(19) United States
(12) Patent Application Publication
(10) Pub. No.: US 2009/0083230 A1
(43) Pub. Date: Mar. 26, 2009

(54) APPARATUS AND METHOD FOR SUPPORTING INFORMATION SEARCHES

(75) Inventors: Nayuko Watanabe, Kanagawa (JP); Yasuto Ishitani, Kanagawa (JP); Masaru Suzuki, Kanagawa (JP)

Correspondence Address: Gregory Turocy;Amin, Turocy & Calvin, LLP, 24TH Floor, 1900 East 9th Street, Cleveland, OH, 44114, US

(73) Assignee: KABUSHIKI KAISHA TOSHIBA, Tokyo (JP)

(21) Appl. No.: 12/210,399

(22) Filed: Sep. 15, 2008

(30) Foreign Application Priority Data
Sep. 25, 2007 (JP) 2007-247993

(51) Int. Cl. G06F 7/06; G06F 17/30

(52) U.S. Cl. 707/3; 707/E17.014

(57) ABSTRACT

An information search supporting apparatus includes a search history storage storing keywords, narrow-down criteria for each of the keywords, and keyword attributes expressing meanings of the keywords, while keeping them in correspondence; and a search number-of-times storage storing number of times indicating how many times one or both of the keywords and the narrow-down criteria have each been used in searches. The apparatus receives input of a character string, obtains a character string attribute expressing the meaning thereof, obtains, from the search history storage, any of the keywords and narrow-down criteria that are in association with the keyword attribute matching the character string attribute, further obtains, from the search number-of-times storage, the number corresponding to one or both of the obtained keywords and narrow-down criteria, and generates a screen on which the obtained keywords and narrow-down criteria are rearranged based on the number and that prompts the user to specify a new search criterion.

### CROSS-REFERENCE TO RELATED APPLICATIONS

This application is based upon and claims the benefit of priority from the prior Japanese Patent Application No. 2007-247993, filed on Sep. 25, 2007; the entire contents of which are incorporated herein by reference.

### BACKGROUND OF THE INVENTION

1. Field of the Invention

The present invention relates to a supporting apparatus and a supporting method for conducting an information search based on an input from a user.

2. Description of the Related Art

In recent years, as the capacities of storage devices have become larger, Personal Computers (PCs) have a tendency to store therein a large volume of information including files and e-mail messages. As a result, it has become difficult for the users to organize the large volume of information efficiently and to search for a desired piece of information. To solve this problem, a desktop search method that can be used for conducting a search in the information stored in a PC in a traversal manner has been proposed. By using the desktop search method and providing an appropriate query, it is possible to conduct a search within the storage device and obtain a search result promptly.

When the desktop search method is used, it is often the case that a user repeatedly conducts a search with similar search criteria many times. In consideration of this situation, a technique has been proposed by which the search criteria are stored in advance in a virtual folder placed in a search folder. This technique makes it possible for the user to have the most updated result displayed by selecting the virtual folder. As a result, the user no longer has to conduct the same search again and again.

Further, JP-A 2005-43999 (KOKAI) describes a technique by which, when a search result is to be displayed, the order in which search candidates are presented is determined based on the number of times each of the search candidates has been selected and the number of times each of the search candidates has been presented. This technique makes it possible to reduce the load on the user caused by the operations during the searches, because the search candidates are presented in an order, while higher priority are given to more useful search candidates.

However, the users do not wish to conduct searches by using completely the same search criterion all the time. It is often the case that the users wish to conduct searches that are related to one another but use mutually different search criteria. According to the conventional technique, when conducting a search with a search criterion that is not completely the same as the one used before, the user needs to input a search criterion again. Thus, the conventional technique is not able to reduce the load on the user caused by the operations.

Also, although the technique described in JP-A 2005-43999 (KOKAI) is able to display the search results based on the levels of their usefulness, the technique is not able to reduce the load on the user caused by the operations to specify search criteria.

### SUMMARY OF THE INVENTION

According to one aspect of the present invention, an information search supporting apparatus includes a search history storage unit that stores keywords that have been used in searches, narrow-down criteria for each of the keywords, and keyword attributes each showing an attribute that expresses a meaning of a corresponding one of the keywords, in association with each other; a search number-of-times storage unit that stores a search number of times indicating how many times at least one of each keyword and each narrow-down criterion has been used in the searches; an input receiving unit that receives an input of a character string; an attribute obtaining unit that obtains, based on the character string, a character string attribute showing an attribute that expresses a meaning of the character string; a history obtaining unit that obtains, from the search history storage unit, a keyword and a narrow-down criterion for the keyword, which are associated with a keyword attribute that matches the character string attribute; a search number-of-times obtaining unit that obtains, from the search number-of-times storage unit, the number of times of at least one of the keyword and the narrow-down criterion; a rearranging unit that rearranges the keywords and the narrow-down criteria, based on the number of times of at least one of the keywords and the narrow-down criteria; and a screen generating unit that generates a screen for supporting to specify a new search criterion, wherein the keywords and the narrow-down criteria are rearranged by the rearranging unit.

According to another aspect of the present invention, an information search supporting method includes storing, in a search history storage unit, keywords that have been used in searches, narrow-down criteria for each of the keywords, and keyword attributes each showing an attribute that expresses a meaning of a corresponding one of the keywords, in association with each other; storing, in a search number-of-times storage unit, a search number of times indicating how many times at least one of each keyword and each narrow-down criterion has been used in the searches; receiving an input of a character string; obtaining, based on the character string, a character string attribute showing an attribute that expresses a meaning of the character string; obtaining, from the search history storage unit, a keyword and a narrow-down criterion for the keyword, which are associated with a keyword attribute that matches the character string attribute; obtaining, from the search number-of-times storage unit, the number of times of at least one of the keyword and the narrow-down criterion; rearranging the keywords and the narrow-down criteria, based on the number of times of at least one of the keywords and the narrow-down criteria; and generating a screen for supporting to specify a new search criterion, wherein the keywords and the narrow-down criteria are rearranged by the rearranging.

### BRIEF DESCRIPTION OF THE DRAWINGS

FIG. 1 is a block diagram of an information search supporting apparatus according to a first embodiment;

FIG. 2 is a drawing of a table structure of a surface character string correspondence dictionary according to the first embodiment;

FIG. 3 is a drawing of a table structure of a pattern correspondence dictionary according to the first embodiment;

FIG. 4 is a drawing of a table structure of a search history correspondence table according to the first embodiment;

FIG. 5 is a drawing of a table structure of a keyword search number-of-times table according to the first embodiment;

FIG. 6 is a drawing of a table structure of a narrow-down criterion search number-of-times table according to the first embodiment;

FIG. 7 is a drawing of an example of a search initial screen according to the first embodiment;

FIG. 8 is a drawing of an example in which character strings have been input in the keyword input box on the search screen shown in FIG. 7;

FIG. 9 is a drawing for explaining a concept of obtaining meaning attributes when a plurality of character strings have been input in a keyword input box on a search screen;

FIG. 10 is a drawing for explaining a concept of extracting search history records, based on character strings that have been input on a search screen and the meaning attributes of the input character strings;

FIG. 11 is a drawing of a first example in which the records in a list of history extraction results that have been extracted are rearranged;

FIG. 12 is a drawing of a second example in which the records in a list of history extraction results that have been extracted are rearranged;

FIG. 13 is a drawing of an example of a search screen that has been generated by a screen generating unit;

FIG. 14 is a drawing of an example of a search screen containing search history records that has been generated by the screen generating unit;

FIG. 15 is a drawing for explaining an example of a search screen on which a selection of a set of narrow-down criteria has been received, the selection being made out of search history records that are rearranged based on the search numbers of times;

FIG. 16 is a drawing of an example of a search screen on which the selected set of narrow-down criteria is reflected;

FIG. 17 is a drawing of an example in which records have been added to the search history correspondence table according to the first embodiment;

FIG. 18 is a drawing of an example of a search screen in which check boxes are provided, according to a modification example of the first embodiment;

FIG. 19 is a drawing of an example of a search screen on which a plurality of search history records have been selected, according to the modification example;

FIG. 20 is a flowchart of a processing procedure performed by an information search supporting apparatus according to the first embodiment, up to a process in which a search screen containing search history records is generated and displayed;

FIG. 21 is a flowchart of a procedure performed by an attribute obtaining unit according to the first embodiment to obtain meaning attributes;

FIG. 22 is a flowchart of a procedure performed by a history obtaining unit according to the first embodiment to obtain a list of history extraction results;

FIG. 23 is a flowchart of a processing procedure performed by the information search supporting apparatus according to the first embodiment, when a search is conducted;

FIG. 24 is a block diagram of an information search supporting apparatus according to another modification example of the first embodiment;

FIG. 25 is a drawing of a table structure of a search history ID storing table;

FIG. 26 is a drawing of an example of search frequency levels that have been obtained by a search frequency obtaining unit;

FIG. 27 is a block diagram of an information search supporting apparatus according to a second embodiment;

FIG. 28 is a drawing of a table structure of a keyword search number-of-times table according to the second embodiment;

FIG. 29 is a drawing of a table structure of a search history correspondence table according to the second embodiment;

FIG. 30 is a drawing of an example of a search screen according to the second embodiment;

FIG. 31 is a flowchart of a processing procedure performed by the information search supporting apparatus according to the second embodiment, up to a process in which a search screen containing search history records is generated and displayed;

FIG. 32 is a flowchart of a procedure performed by the information search supporting apparatus according to the second embodiment to obtain history extraction results;

FIG. 33 is a flowchart of a processing procedure performed by the information search supporting apparatus according to the second embodiment, when a search is conducted;

FIG. 34 is a block diagram of an information search supporting apparatus according to a third embodiment;

FIG. 35 is a drawing of table structures of narrow-down criterion search number-of-times tables;

FIG. 36 is a drawing of an example of a search screen according to the third embodiment;

FIG. 37 is a flowchart of a processing procedure performed by the information search supporting apparatus according to the third embodiment, when a search is conducted;

FIG. 38 is a block diagram of an information search supporting apparatus according to a fourth embodiment;

FIG. 39 is a drawing of an example of a search screen according to the fourth embodiment;

FIG. 40 is a drawing of an example of a search screen containing search history records according to the fourth embodiment;

FIG. 41 is a drawing of an example of a search screen on which a result of selecting a search history record is reflected, according to the fourth embodiment;

FIG. 42 is a block diagram of an information search supporting apparatus according to a fifth embodiment;

FIG. 43 is a drawing of a table structure of a search history correspondence table according to the fifth embodiment;

FIG. 44 is a drawing of an example of a search screen according to the fifth embodiment;

FIG. 45 is a block diagram of an information search supporting apparatus according to a sixth embodiment;

FIG. 46 is a drawing of an example in which a character string is selected in an Internet browser or a document browsing application;

FIG. 47 is a drawing of an example in which a menu containing sets of narrow-down criteria are displayed based on a result of selecting the character string; and

FIG. 48 is a hardware configuration diagram of an information search supporting apparatus.

### DETAILED DESCRIPTION OF THE INVENTION

Exemplary embodiments of an information search supporting apparatus and an information search supporting method according to the present invention will be explained in detail, with reference to the accompanying drawings. It is possible to implement the information search supporting apparatus in various forms, other than those described in the exemplary embodiments. For example, it is possible to configure the information search supporting apparatus to be included in an information search apparatus.

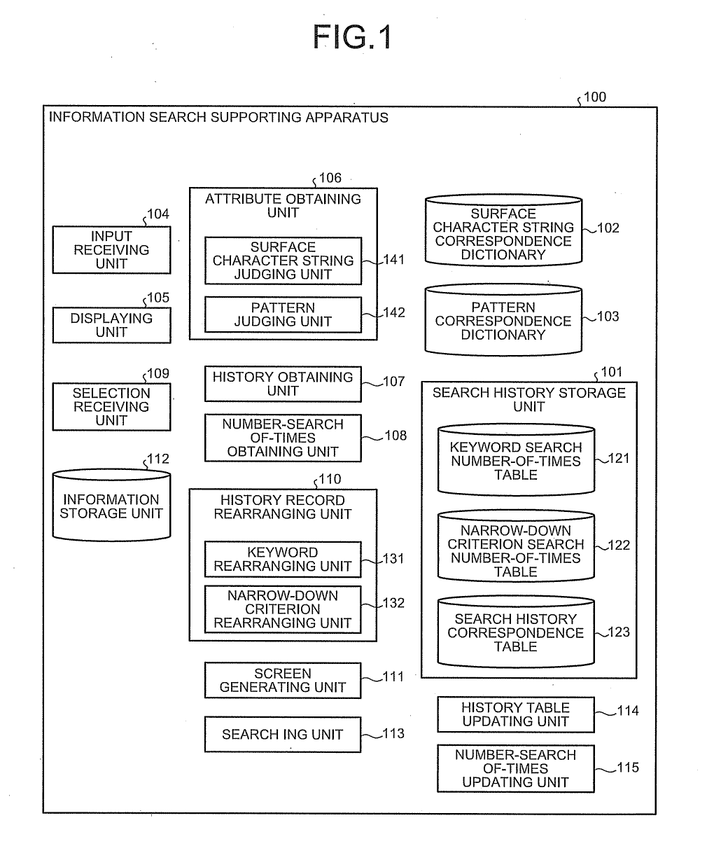

As shown in FIG. 1, an information search supporting apparatus 100 according to a first embodiment includes: a search history storage unit 101; a surface character string correspondence dictionary 102; a pattern correspondence dictionary 103; an input receiving unit 104; a displaying unit 105; an attribute obtaining unit 106; a history obtaining unit 107; a search number-of-times obtaining unit 108; a history record rearranging unit 110; a selection receiving unit 109; a screen generating unit 111; an information storage unit 112; a searching unit 113; a history table updating unit 114; and a search number-of-times updating unit 115.

It is possible to realize the information search supporting apparatus 100 by installing, in a Personal Computer (PC), an application program for conducting information searches. The PC with which the information search supporting apparatus 100 is configured may be in any form, e.g., a notebook PC. It is also acceptable to configure the information search supporting apparatus 100 with a hardware device other than a PC, such as a Personal Digital Assistant.

The information search supporting apparatus 100 includes a liquid crystal display (not shown) that serves as a displaying device. With this arrangement, the information search supporting apparatus 100 displays a search screen that has been generated and results of searches. The search screen serves as an interface while the user conduct searches.

Further, the information search supporting apparatus 100 includes an input device like a keyboard and/or a mouse (not shown). With this arrangement, the user is able to input texts and/or coordinates to the displayed search interface. Another arrangement is acceptable in which the constituent elements of the information search supporting apparatus 100 shown in FIG. 1 are realized by incorporating add-on software into an existing searching system.

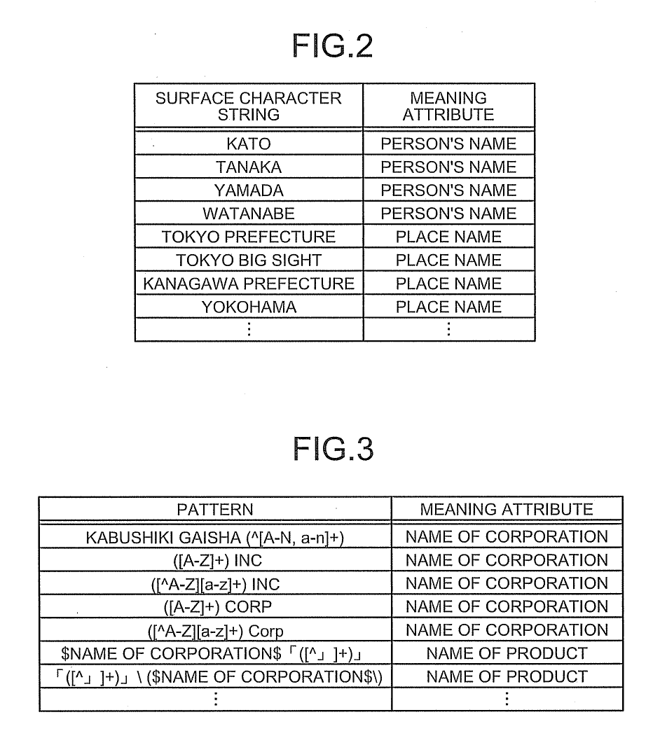

The surface character string correspondence dictionary 102 is a dictionary used for obtaining a corresponding meaning attribute based on a surface character string. FIG. 2 is a drawing of an example of a data structure of the surface character string correspondence dictionary 102. As shown in FIG. 2, the surface character string correspondence dictionary 102 stores therein surface character strings and meaning attributes, in association with each other. For example, in the example of the surface character string correspondence dictionary 102 shown in FIG. 2, a character string “Kato” is associated with a meaning attribute “Person's Name” in the uppermost record. According to the first embodiment, the surface character string correspondence dictionary 102 is provided in the information search supporting apparatus 100; however, another arrangement is acceptable in which the surface character string correspondence dictionary 102 is provided in a server that is connected to the information search supporting apparatus 100 via a network.

Each of the meaning attributes is an attribute that expresses the meaning of a corresponding surface character string (i.e., a word or a phrase). For example, the meaning attribute of each of the words “Yamada” and “Kato” is “Person's Name”. The meaning attribute of each of the words “Tozai Electric” and “Nanboku Trading” is “Corporation”. The meaning attribute of each of the words “Yokohama” and “Chinatown” is “Place Name”.

The pattern correspondence dictionary 103 is a dictionary used for obtaining a corresponding meaning attribute based on a pattern of a character string. FIG. 3 is a drawing of an example of a data structure of the pattern correspondence dictionary 103. As shown in FIG. 3, the pattern correspondence dictionary 103 stores therein patterns used for making a judgment on each character string and meaning attributes, in association with each other. According to the first embodiment, the pattern correspondence dictionary 103 is provided in the information search supporting apparatus 100; however, another arrangement is acceptable in which the pattern correspondence dictionary 103 is provided in a server that is connected to the information search supporting apparatus 100 via a network.

For example, in the example of the pattern correspondence dictionary 103 shown in FIG. 3, the pattern “KABUSHIKI GAISHA ([̂A-N, a-n]+)” (Note that this is Japanese example, “A-N” indicates hiragana, “a-n” indicates katakana) is associated with a meaning attribute “Name of Corporation” in the uppermost record. As another example, the pattern “$Name of Corporation$‘ ([̂’]+)” is associated with a meaning attribute “Product Name” in the sixth record. The patterns are described by using the standardized expressions in Perl language. For example, “$Name of Corporation$‘ ([̂’]+)” matches “Tozai Electric ‘GB 21’”.

The search history storage unit 101 stores therein a search history correspondence table 123, a keyword search number-of-times table 121, and a narrow-down criterion search number-of-times table 122.

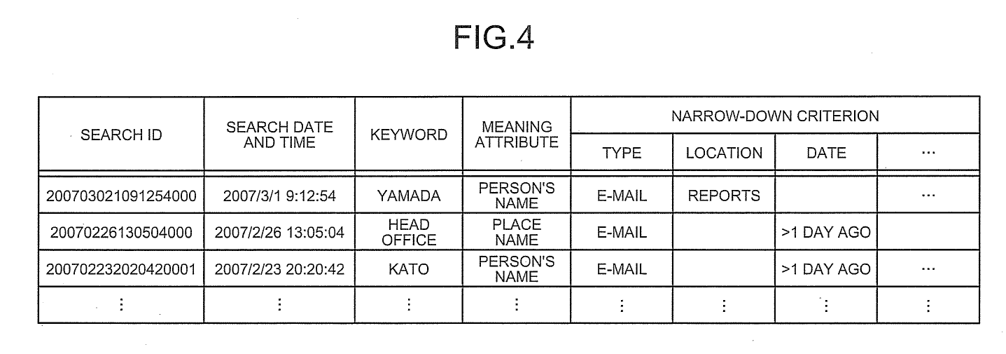

The search history correspondence table 123 stores therein search criteria that have been specified by the user when searches are conducted. As shown in FIG. 4, the search history correspondence table 123 stores therein search IDs, dates and times of searches, keywords, meaning attributes, and sets of narrow-down criteria, in association with each other. For example, each of the sets of narrow-down criteria is related to any of type, location, and date.

Each of the search IDs is a unique ID that is assigned to a different one of the sets of search criteria. Each of the keywords is a character string that has been input by the user when a search is to be conducted. Each of the meaning attributes is a meaning attribute of the corresponding one of the keywords. Each of the sets of narrow-down criteria includes one or more criteria that have been specified for the purpose of narrowing down the targets of the search.

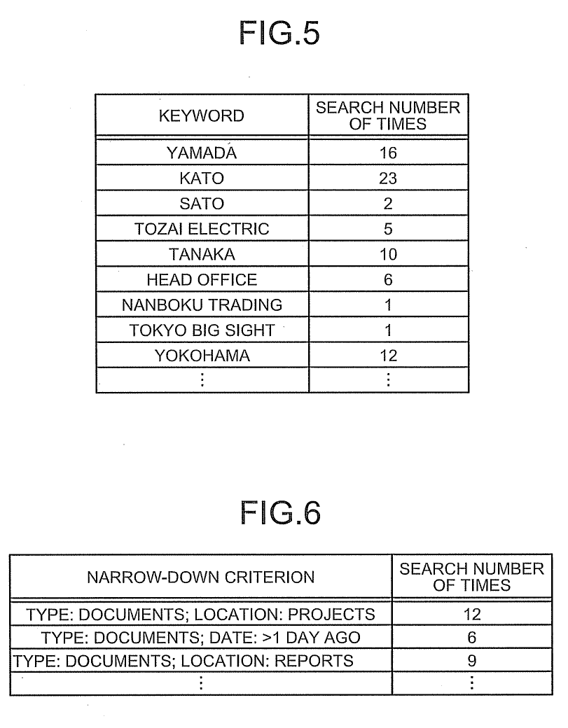

The keyword search number-of-times table 121 stores therein, for each of the character strings that have been input as the keywords when the searches are conducted, a numerical value (hereinafter, the “search number of times”), indicating how many times the character string has been used as a search criterion. As shown in FIG. 5, the keyword search number-of-times table 121 stores therein keywords and the search numbers of times, in association with each other.

The narrow-down criterion search number-of-times table 122 stores therein, for each of the sets of narrow-down criteria that have been specified when the searches are conducted, a numerical value (hereinafter, the “search number of times”) indicating how many times the set of narrow-down criteria has been used. As shown in FIG. 6, the narrow-down criterion search number-of-times table 122 stores therein the sets of narrow-down criteria and the search numbers of times, in association with each other.

In the keyword search number-of-times table 121 and the narrow-down criterion search number-of-times table 122, the value of each of the search numbers of times is set to “0” in the initial state. After a search is Conducted and a search history record is stored, the search numbers of times corresponding to the keywords and to the set of narrow-down criteria that have been specified as the search criteria are incremented by “1” in each of these tables. As a result, for each of the keywords and the set of narrow-down criteria, it is possible to store the search number of times indicating how many times the keyword or the set of narrow-down criteria has been used. According to the first embodiment, the total search number of times is used; however, another arrangement is acceptable in which a search frequency level indicating the monthly average of the search number of times is used.

The information storage unit 112 stores therein information being the target of the searches conducted by the user. The information may be any type of information that can serve as the target of the searches conducted by the user, e.g., e-mail messages or document data.

The displaying unit 105 performs a process to display information on the liquid crystal display device (not shown). For example, the displaying unit 105 performs a process to display a search screen and a process to display a result of a search.

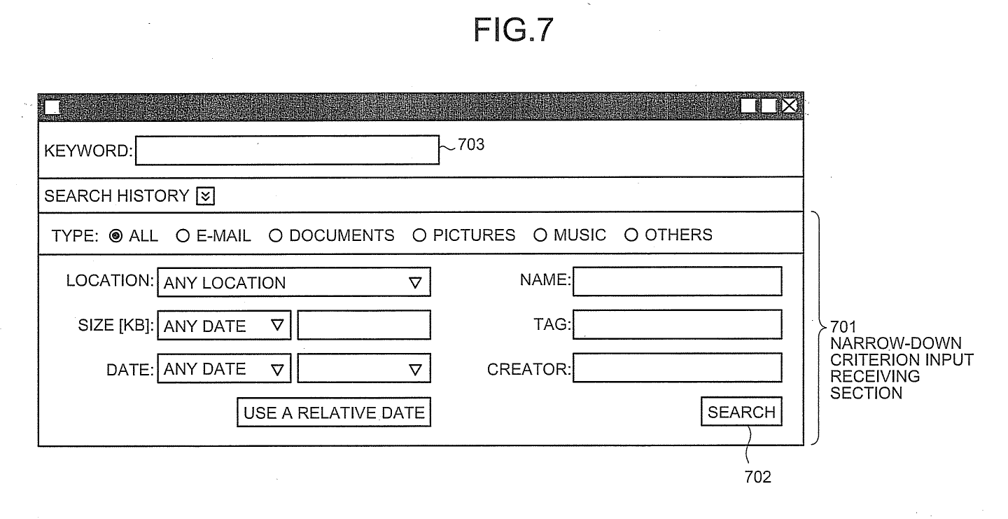

Also, the displaying unit 105 performs a process to display a screen like the one shown in FIG. 7, as a search initial screen. A keyword input box 703 is a box into which one or more character strings specified by the user as keywords can be input. In other words, it is possible to input a plurality of character strings in the keyword input box 703. A narrow-down criterion input receiving section 701 is a section in which the criteria used for narrowing down the information being the target of a search are input or selected. When a “search” button 702 is pushed, a search is started.

After that, the displaying unit 105 displays a search screen that contains appropriate search history records, based on the character strings that have been input by the user as the keywords and the like. The search screen is generated by the screen generating unit 111.

The input receiving unit 104 receives an input of one or more character strings that are to be used as the keywords in the search, from the input device (not shown).

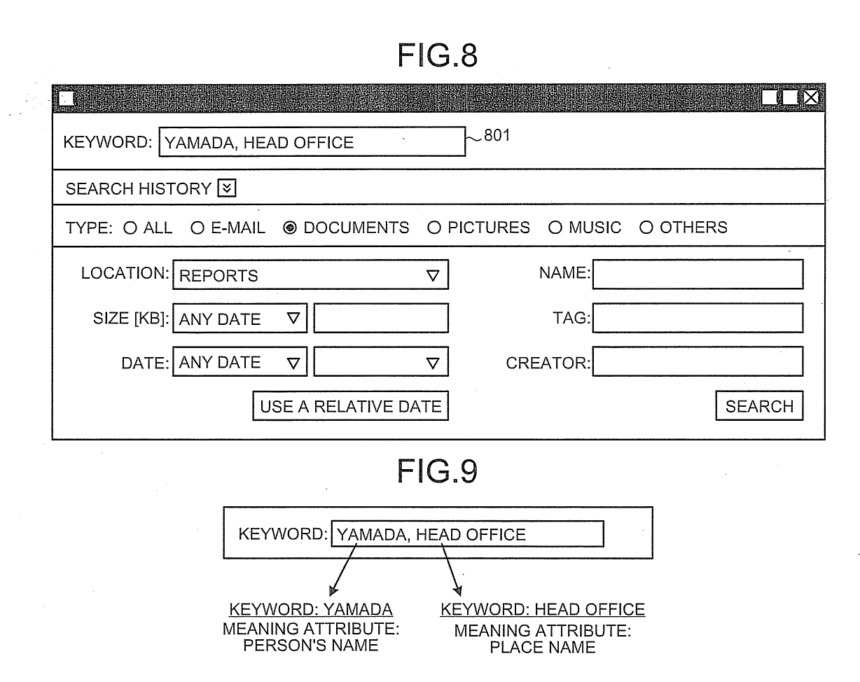

As shown in FIG. 8, the input receiving unit 104 is able to receive an input of a plurality of character strings (e.g., “Yamada” and “Head Office”) through a keyword section 801 on the search screen.

The attribute obtaining unit 106 includes a surface character string judging unit 141 and a pattern judging unit 142 and obtains a meaning attribute of the character string or meaning attributes of the two or more character strings, after the one or more character strings have been received by the input receiving unit 104 as the input.

The surface character string judging unit 141 judges whether each the one or more character strings that have been received as the input matches any of the surface character strings that are stored in the surface character string correspondence dictionary 102. In the case where the surface character string judging unit 141 has judged in the affirmative, the meaning attribute that is stored in association with the surface character string is specified as the meaning attribute of the input character string.

The pattern judging unit 142 judges whether each of the one or more character strings that have been received as the input matches any of the conditions of the patterns that are registered in the pattern correspondence dictionary 103. In the case where the pattern judging unit 142 has judged in the affirmative, the meaning attribute that is stored in association with the pattern is specified as the meaning attribute of the input character string.

As shown in FIG. 9, in the case where “Yamada” and “Head Office” have been input in the keyword input box on the search screen, the attribute obtaining unit 106 obtains the meaning attributes “Person's Name” and “Place Name” that correspond to “Yamada” and “Head Office”, respectively.

The history obtaining unit 107 obtains, out of the search history correspondence table 123, any of the search history records in each of which any of the input character strings is used as a keyword as well as any of the search history records each of which is associated with the meaning attribute that matches any of the meaning attributes of the keywords. As explained above, the meaning attributes of the keywords have been obtained by the attribute obtaining unit 106.

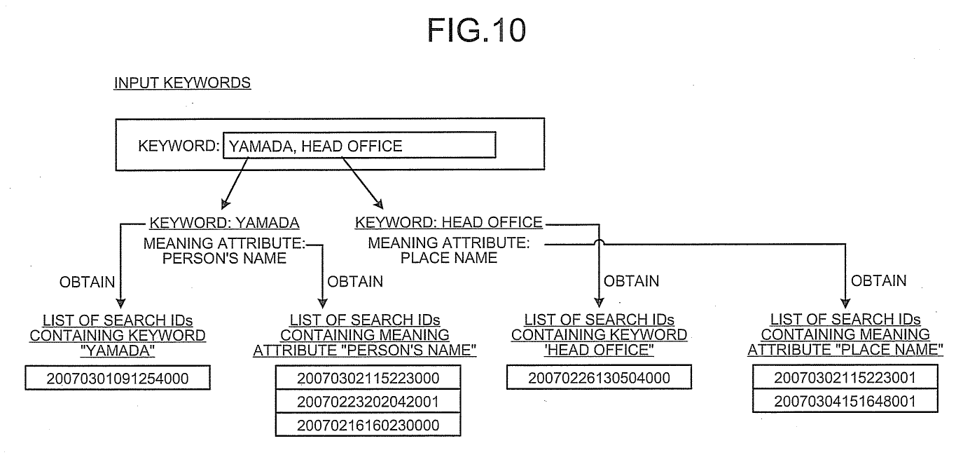

As shown in FIG. 10, for each of the input keywords and each of the meaning attributes that have been obtained based on the keywords, the history obtaining unit 107 obtains one or more search history records out of the search history correspondence table 123 while the obtained search history records are arranged in a list. The list will be referred to as a list of history extraction results. In the example shown in FIG. 10, only the lists of search IDs are shown as the search history records; however, the lists of search IDs are associated with the keywords, the sets of narrow-down criteria, and the like, as explained above.

The search number-of-times obtaining unit 108 obtains, out of the keyword search number-of-times table 121, the numerical values (i.e., the search numbers of times) indicating how many times the keywords obtained by the history obtaining unit 107 have each been used. Also, the search number-of-times obtaining unit 108 obtains, out of the narrow-down criterion search number-of-times table 122, the numerical values (i.e., the search numbers of times) indicating how many times the sets of narrow-down criteria obtained by the history obtaining unit 107 have each been used.

The history record rearranging unit 110 includes a keyword rearranging unit 131 and a narrow-down criterion rearranging unit 132 and rearranges the history records that have been obtained by the history obtaining unit 107, according to the search numbers of times (i.e., the numerical values) that have been obtained by the search number-of-times obtaining unit 108.

The keyword rearranging unit 131 rearranges the records in the list of history extraction results obtained by the history obtaining unit 107, according to the numerical values (i.e., the search number of times) corresponding to the keywords that have been obtained by the search number-of-times obtaining unit 108. In the case where there are two or more keywords, one method is to rearrange the records within each of the lists of history extraction results that are respectively prepared for the keywords and the meaning attributes, according to the search numbers of times. Another method is to rearrange the records within a list obtained by merging all the lists of history extraction results, according to the search numbers of times corresponding to the keywords.

The narrow-down criterion rearranging unit 132 rearranges the records in the list of history extraction results obtained by the history obtaining unit 107, according to the numerical values (i.e., the search numbers of times) corresponding to the sets of narrow-down criteria that have been obtained by the search number-of-times obtaining unit 108.

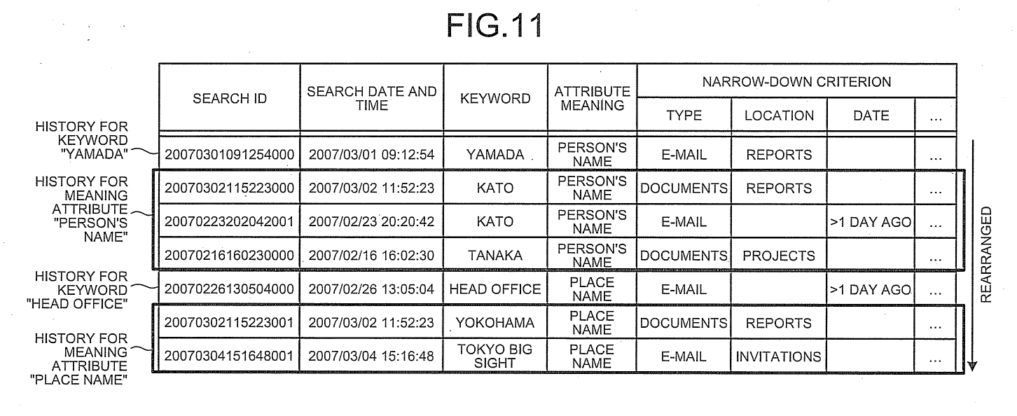

As shown in FIG. 11, for each of the keywords and each of the meaning attributes, the history record rearranging unit 110 rearranges the order in which the search history records are positioned in the list of history extraction results, based on the search numbers of times.

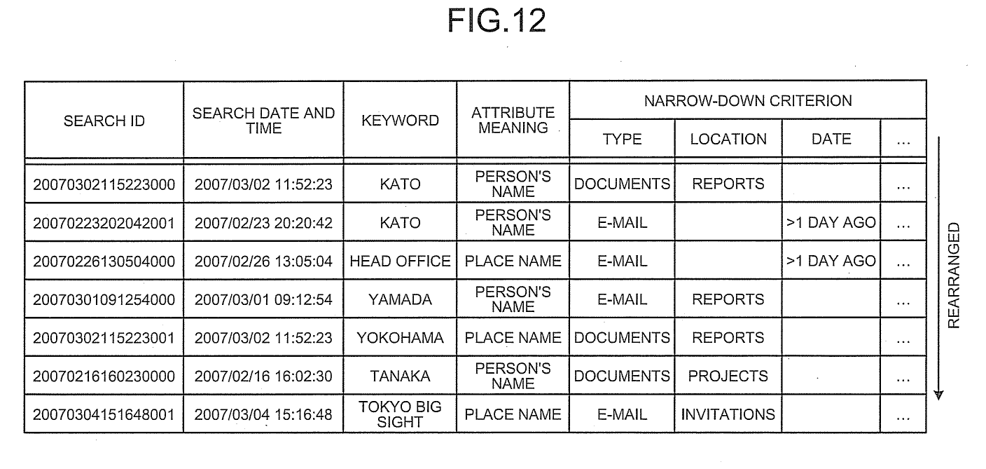

Alternatively, as shown in FIG. 12, another arrangement is acceptable in which the history record rearranging unit 110 merges all the lists of history extraction results together that have respectively been obtained for the keywords and the meaning attributes and rearranges the records within the merged list, according to the search numbers of times corresponding to the keywords or the sets of narrow-down criteria.

The method for rearranging the records used by the information search supporting apparatus 100 according to the first embodiment is not limited to the examples described above. It is acceptable to use one of the methods for rearranging the records described above. Alternatively, it is acceptable to change from one method for rearranging the records to another, according to a request from the user. Further, it is acceptable to use any existing algorithm as the algorithm used for sorting the records. It is also acceptable to use a new algorithm that is created.

The screen generating unit 111 generates a search screen. The screen generating unit 111 generates a search screen on which the search history records (containing the keywords and the narrow-down criteria) are displayed in the order rearranged by the history record rearranging unit 110 and on which the user is prompted to specify a new search criterion.

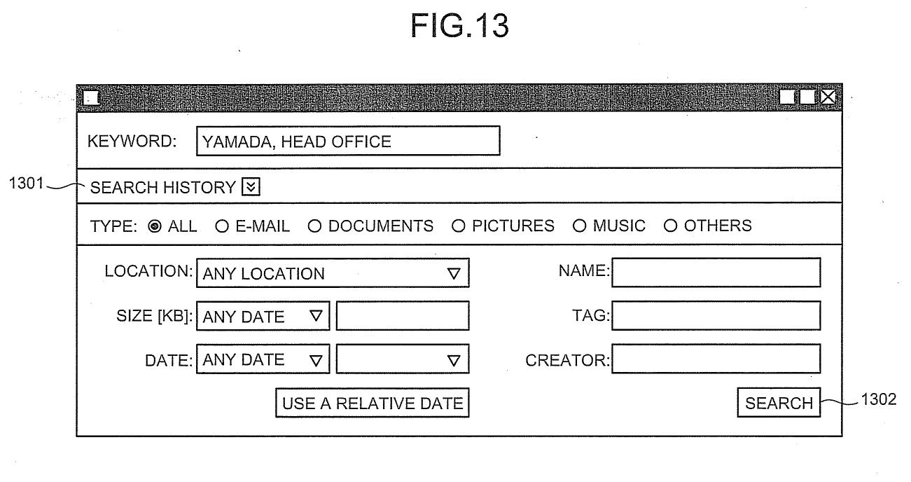

For example, in the case where, after the displaying unit 105 displays a search screen shown in FIG. 13, “Yamada, Head office” has been input as the keywords, and a “search history” button 1301 has been pushed, the screen generating unit 111 starts generating a new search screen that contains search history records.

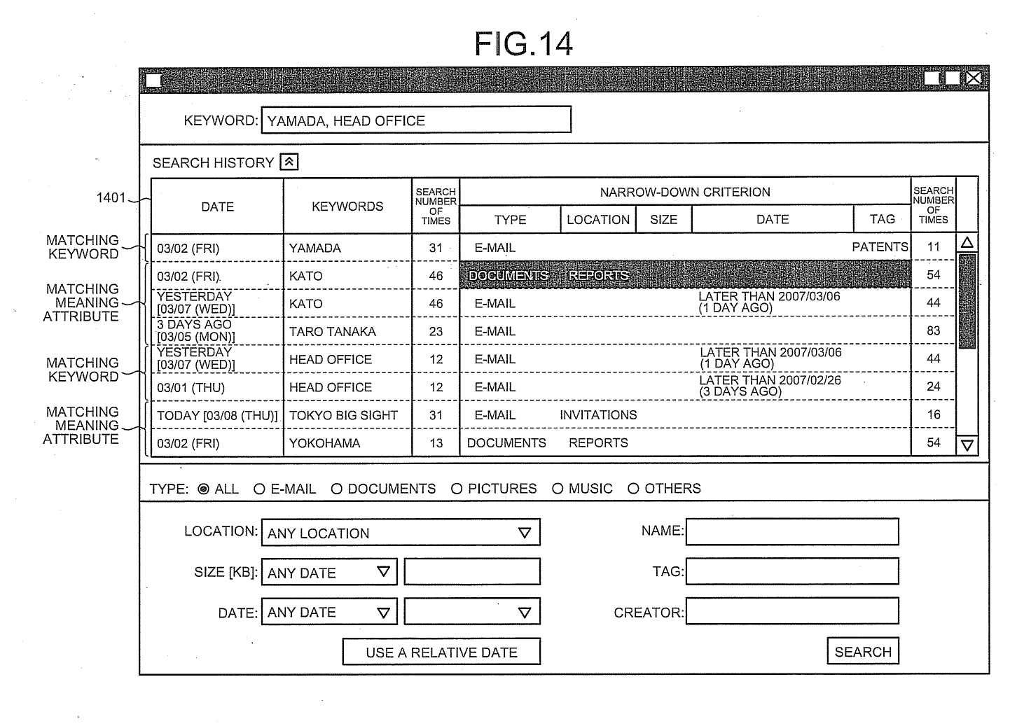

As shown in FIG. 14, the search screen that has been generated by the screen generating unit 111 contains the search history records that have been obtained for each of the character strings input as the keywords and each of the meaning attributes of the character strings. The user is able to input one or more character strings by using an input device such as a keyboard. Also, the user is able to input the narrow-down criteria into the narrow-down criterion input section provided at the bottom of the search screen, by using an input device. When a search button 1302 is pushed, the search is conducted.

On the search screen shown in FIG. 14, dates on which searches were conducted, the keywords used in the searches, the meaning attributes of the keywords, the search numbers of times corresponding to the keywords, the sets of narrow-down criteria, and the search numbers of times corresponding to the sets of narrow-down criteria are displayed while being associated with one another.

On the search screen shown in FIG. 14, the user is able to instruct that the search history records should be rearranged in an order according to the search numbers of times corresponding to the sets of narrow-down criteria. For example, an arrangement is acceptable in which the user is able to push, on the search screen, the header of the column showing the search numbers of times corresponding to the sets of narrow-down criteria. With this arrangement, when the user has pushed the header of the column, the search history records are rearranged according to the search numbers of times corresponding to the sets of narrow-down criteria.

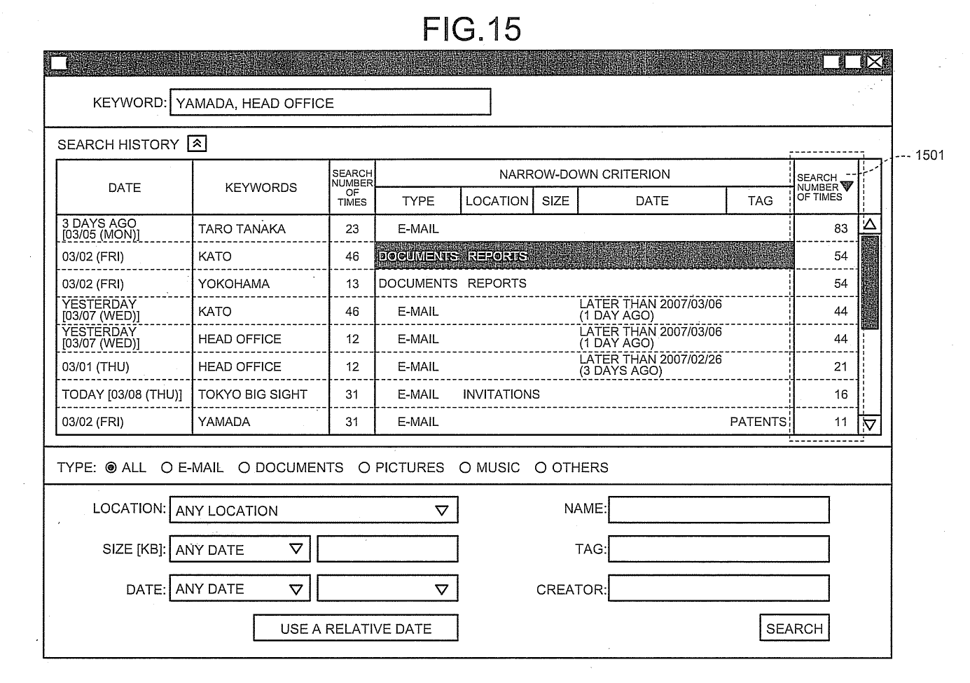

In the case where the user has pushed a header 1501 of the column showing the search numbers of times corresponding to the sets of narrow-down criteria, a search screen as shown in FIG. 15 containing the search history records that are rearranged in an order according to the search numbers of times corresponding to the sets of narrow-down criteria is generated by the screen generating unit 111 and displayed by the displaying unit 105. With this arrangement, by simply selecting one of the sets of narrow-down criteria out of the presented search history records, the user is able to conduct a search with the appropriate search criteria.

The selection receiving unit 109 receives the user's selection of any of the keywords and the narrow-down criteria that are displayed as the search history records on the search screen by the displaying unit 105.

When the user's selection of keywords and/or narrow-down criteria has been received, the screen generating unit 111 generates a search screen on which the selected keywords and/or narrow-down criteria are specified.

For example, as shown in FIG. 14, in the case where the selection receiving unit 109 has received the user's selection of “Documents, Reports” as a set of narrow-down criteria, the screen generating unit 111 generates a search screen on which the selected set of narrow-down criteria is reflected.

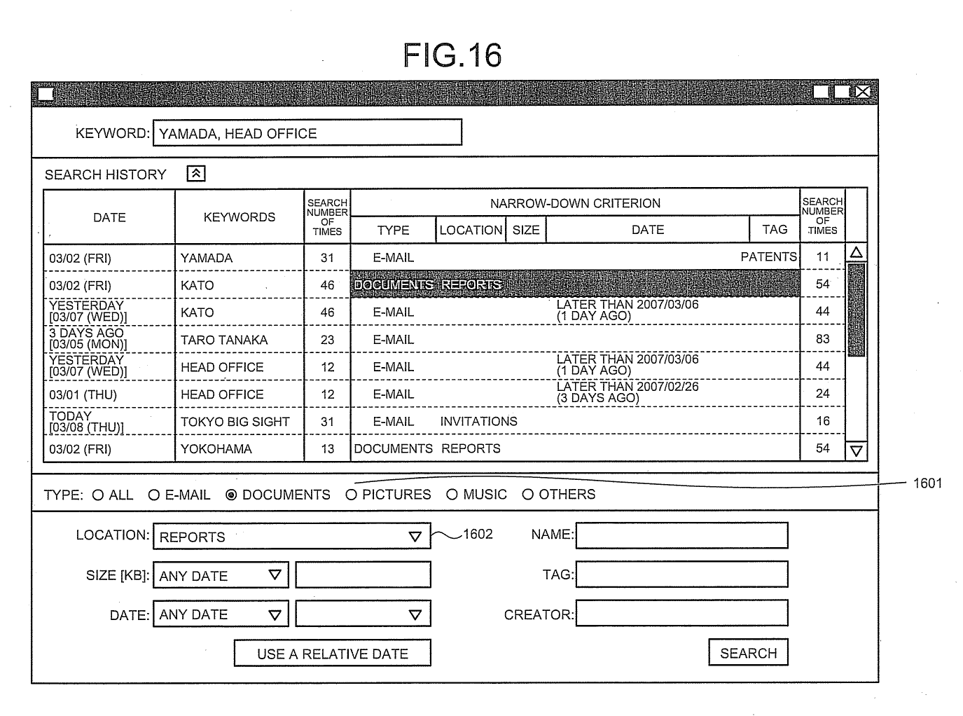

As a result, as shown in FIG. 16, a search screen on which “Documents” 1601 is specified as the type, and “Reports” 1602 is specified as the location is generated by the screen generating unit 111 and displayed by the displaying unit 105. As explained above, when the user has selected the set of narrow-down criteria that he/she wishes to use out of the presented search history records, the selected set of narrow-down criteria is reflected in the narrow-down criterion input section, as shown in the example of the search screen in FIG. 16. By simply pushing the “search” button in this situation, the user is able to conduct a search. Alternatively, the user is also able to conduct a search after editing the set of narrow-down criteria reflected in the narrow-down criterion input section. With these arrangements, it is possible to reduce the load on the user caused by the operations to specify the narrow-down criteria.

Another arrangement is acceptable in which, instead of receiving one search history record with the entire set of narrow-down criteria, the selection receiving unit 109 receives the user's selection of an individual criterion that has been selected out of the set of narrow-down criteria contained in one search history record. For example, an arrangement is acceptable in which, in the case where “Type: Documents; Location: Projects” is displayed as a set of narrow-down criteria, the user is able to select only the narrow-down criterion “Location: Projects”. Yet another arrangement is acceptable in which the selection receiving unit 109 receives a plurality of search history records as the user's selection, instead of only one search history record.

The searching unit 113 searches in the information storage unit 112 for information (i.e., document data, e-mail messages, or the like) that satisfies the search criteria (containing the keywords and the narrow-down criteria) that have been specified on the search screen. The result of the search conducted by the searching unit 113 is displayed by the displaying unit 105. Consequently, the user is able to browse the information that he/she wishes to browse. Another arrangement is acceptable in which the searching unit 113 is provided in an external network.

The displaying unit 105 may use any method to display a screen showing the search result. An arrangement is acceptable in which the displaying unit 105 displays the search result screen in a window that is different from the search screen described above. Another arrangement is acceptable in which the displaying unit 105 displays the search result screen on an Internet browser screen. Yet another arrangement is acceptable in which the displaying unit 105 displays the search result screen under the search screen window.

The history table updating unit 114 updates the search history correspondence table 123 by adding the search criteria used by the searching unit 113 to conduct the search. In this situation, the history table updating unit 114 divides the search criteria into a keyword portion and a narrow-down criterion portion. Further, in the case where the keyword portion contains a plurality of character strings, the history table updating unit 114 divides the keyword portion into sections each containing a character string that represents a keyword. Also, the history table updating unit 114 adds search history records each of which includes a set made up of one of the keywords, the set of narrow-down criteria, and the date and time the search was conducted, to the search history correspondence table 123.

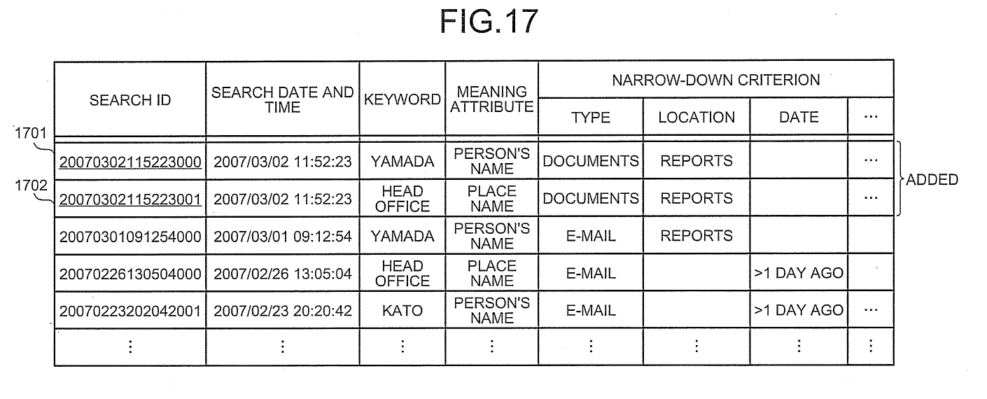

For example, in the case where a search has been conducted by using the search criteria shown in FIG. 16, as shown in a record 1701 in FIG. 17, a search history in which the keyword is “Yamada”, the type in the set of narrow-down criteria is “Documents”, and the location in the set of narrow-down criteria is “Reports” is added to the search history correspondence table 123. Further, as shown in a record 1702 in FIG. 17, another search history in which the keyword is “Head Office”, the type in the set of narrow-down criteria is “Documents”, and the location in the set of narrow-down criteria is “Reports” is also added to the search history correspondence table 123. As explained above, as many records as the number of character strings representing the keywords are added.

The search number-of-times updating unit 115 updates the keyword search number-of-times table 121 by incrementing, by “1”, the search number of times corresponding to each of the keywords contained in the search criteria used by the searching unit 113 to conduct the search. Also, the search number-of-times updating unit 115 updates the narrow-down criterion search number-of-times table 122 by incrementing, by “1”, the search number of times corresponding to each of the sets of narrow-down criteria contained in the search criteria used by the searching unit 113 to conduct the search.

In the description of the information search supporting apparatus 100 according to the first embodiment above, the example in which the search is conducted for the information stored in the information storage unit 112 included in the information search supporting apparatus 100 is explained; however, the search does not necessarily have to be conducted within the apparatus. The search may be conducted in a network. In that situation, the search criteria such as the keywords and the set of narrow-down criteria that have been specified on the search screen are forwarded to a search engine that is provided in the network.

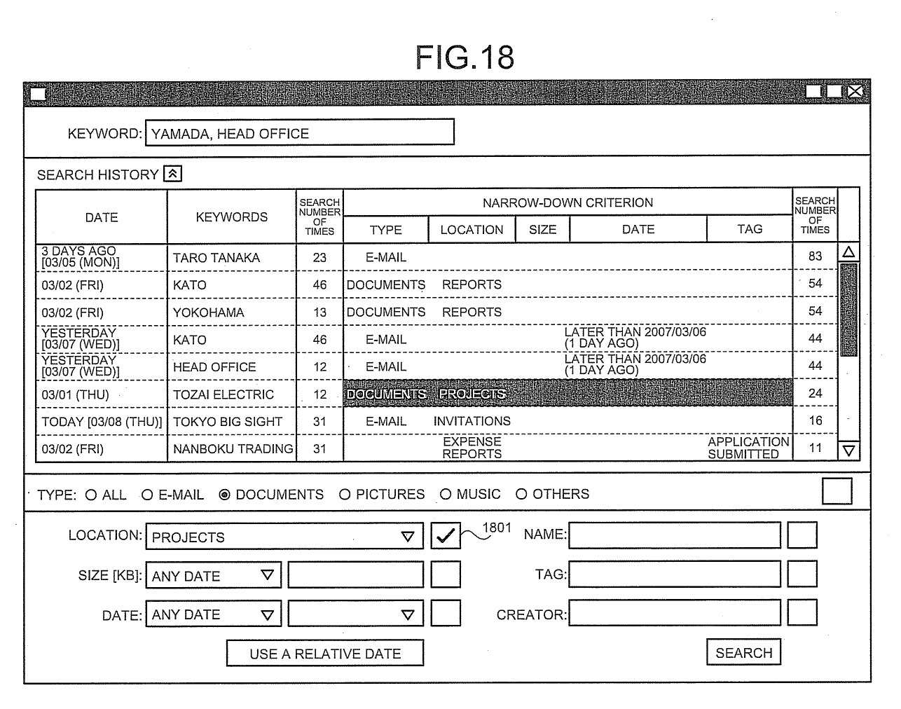

As an example different from the first embodiment, another arrangement is acceptable in which, as shown in FIG. 18, the screen generating unit 111 provides check boxes each of which indicates whether overwriting of the entry is permitted, for the different types of narrow-down criteria shown in the narrow-down criterion input section at the bottom of the search screen. Let us explain an example in which the user has selected “Type: Documents; Location: Projects” as a set of narrow-down criteria. In this situation, the set of narrow-down criteria is reflected in the narrow-down criterion input section.

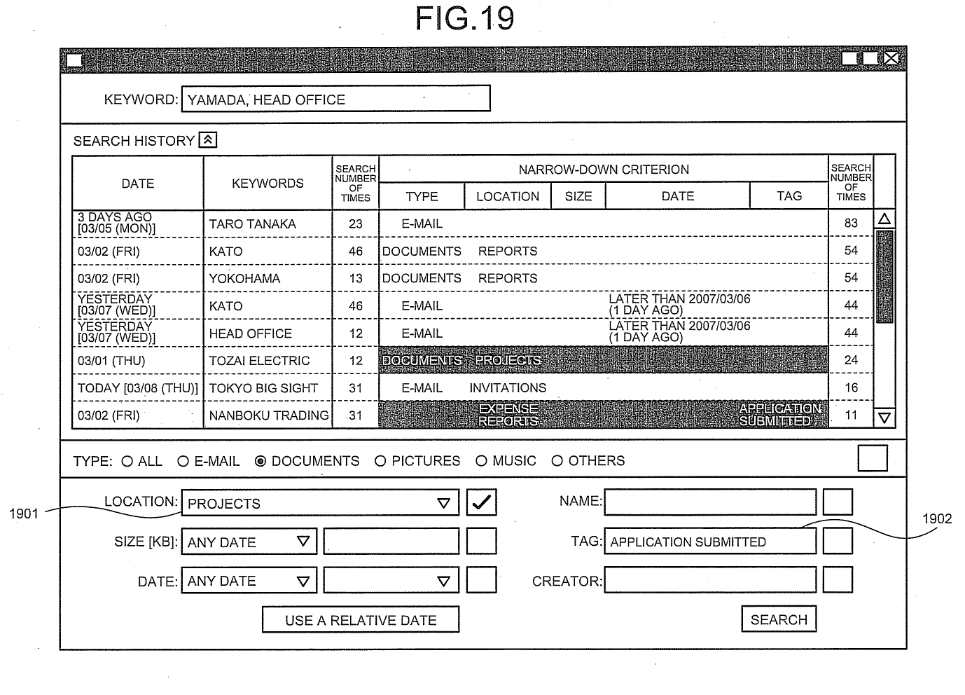

When the user has put a check in a check box 1801, overwriting of the input “Projects” specified as the location in the set of narrow-down criteria is prohibited. As a result, the “Projects” is confirmed as a narrow-down criterion. Let us further explain an example in which, in the situation described above, the user has selected, out of the search history, a search history record in which “Expense Reports” is specified as the location, and “Application Submitted” is specified as the tag. As shown in FIG. 19, because overwriting is prohibited in this situation, the screen generating unit 111 generates a screen on which “Projects” is specified in the box indicated with a reference character 1901, and “Application Submitted” is specified as a tag in the box indicated with a reference character 1902. As for the type, because the second narrow-down criterion that has been selected by the user does not specify any type, “Documents” remains selected and is not changed.

As explained above, the user is able to specify whether overwriting of any of the narrow-down criteria should be prohibited, by putting checks in the check boxes. Thus, the user is able to specify more appropriate narrow-down criteria. Consequently, it is possible to reduce the load on the user caused by the operations. In other words, the user is able to select a plurality of narrow-down criteria on top of one another.

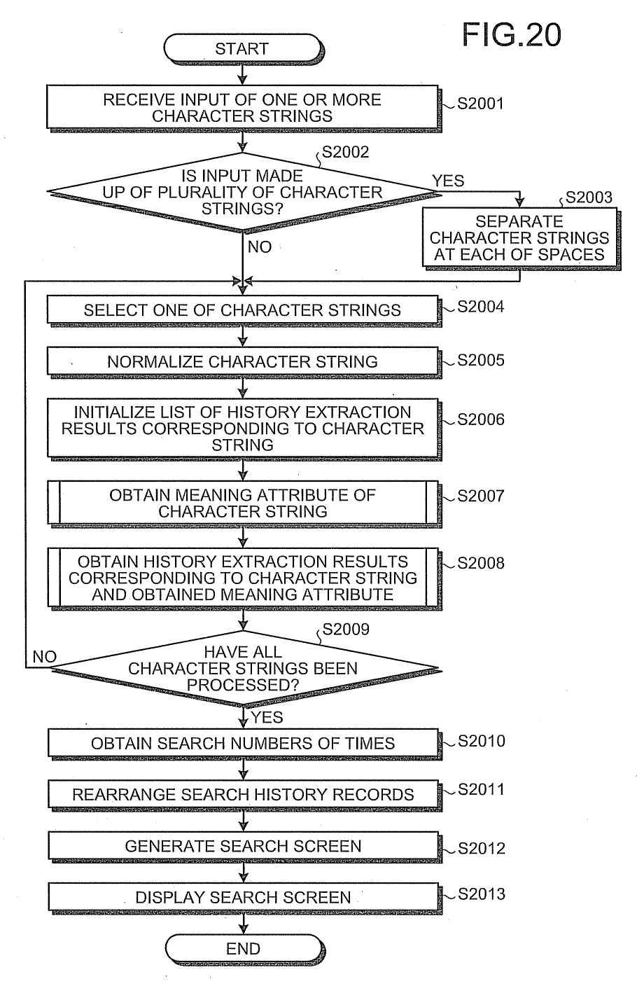

Next, a processing procedure performed by the information search supporting apparatus 100 according to the first embodiment, up to a process in which a search screen containing search history records is generated and displayed, will be explained with reference to FIG. 20.

First, the input receiving unit 104 receives an input of one or more character strings in the keyword input box on a search screen (step S2001).

After that, the input receiving unit 104 judges whether the input in the keyword input box is made up of a plurality of character strings (step S2002). In the case where the input receiving unit 104 has judged that the input is not made up of a plurality of character strings (step S2002: No), no particular process is performed. On the contrary, in the case where the input receiving unit 104 has judged that the input is made up of a plurality of character strings (step S2002: Yes), the input receiving unit 104 separates the character strings that have been input in the keyword input box at each of the spaces (step S2003).

The input receiving unit 104 separates normal character strings at each of spaces (i.e., one-byte spaces and two-byte spaces); however, in the case where two or more character strings are placed between double quotation marks (“ ”) or single quotation marks (‘ ’), the input receiving unit 104 treats the set of character strings as one character string and does not separate it. After that, the input receiving unit 104 outputs the character strings to the attribute obtaining unit 106.

Subsequently, the attribute obtaining unit 106 selects one of the character strings that have been input (step S2004). The attribute obtaining unit 106 then normalizes the selected character string (step S2005). The normalizing process denotes adjusting the surface expression so that a matching process can be performed between the character string and the surface character strings stored in the surface character string correspondence dictionary 102. For example, the attribute obtaining unit 106 converts one-byte characters to two-byte characters.

After that, the attribute obtaining unit 106 initializes the list of history extraction results that corresponds to the character string (step S2006).

Next, the attribute obtaining unit 106 obtains a meaning attribute of the character string (step S2007). Subsequently, the history obtaining unit 107 obtains the history extraction results that correspond to the character string and the obtained meaning attribute (step S2008). It is assumed that each of the history extraction results stores therein, the search date, a keyword, the search number of times corresponding to the keyword, a set of narrow-down criteria, and the search number of times corresponding to the set of narrow-down criteria, in association with each other in the form of a list of history extraction results.

After that, the attribute obtaining unit 106 and the history obtaining unit 107 judge whether all the character strings have been processed (step S2009). In the case where the attribute obtaining unit 106 and the history obtaining unit 107 have judged that not all the character strings have been processed (step S2009: No), the process is started again from step S2004.

In the case where the attribute obtaining unit 106 and the history obtaining unit 107 have judged that all the character strings have been processed (step S2009: Yes), the search number-of-times obtaining unit 108 obtains the search numbers of times corresponding to the keywords and the sets of narrow-down criteria contained in the list of history extraction results, out of the keyword search number-of-times table 121 and the narrow-down criterion search number-of-times table 122 (step S2010).

After that, for each of the character strings and each of the meaning attributes, the history record rearranging unit 110 rearranges the order in which the search history records contained in the list of history extraction results are positioned, according to the search numbers of times, for each of the character strings and the meaning attributes (step S2011).

Subsequently, the screen generating unit 111 generates a search screen that contains the search history records that have been rearranged at step S2011 (step S2012).

After that, the displaying unit 105 displays the generated search screen (step S2013). As a result, on the search screen, the search history records that contain the character strings that have been input by the user and/or the meaning attributes of the input character strings are displayed in the order according to the search numbers of times.

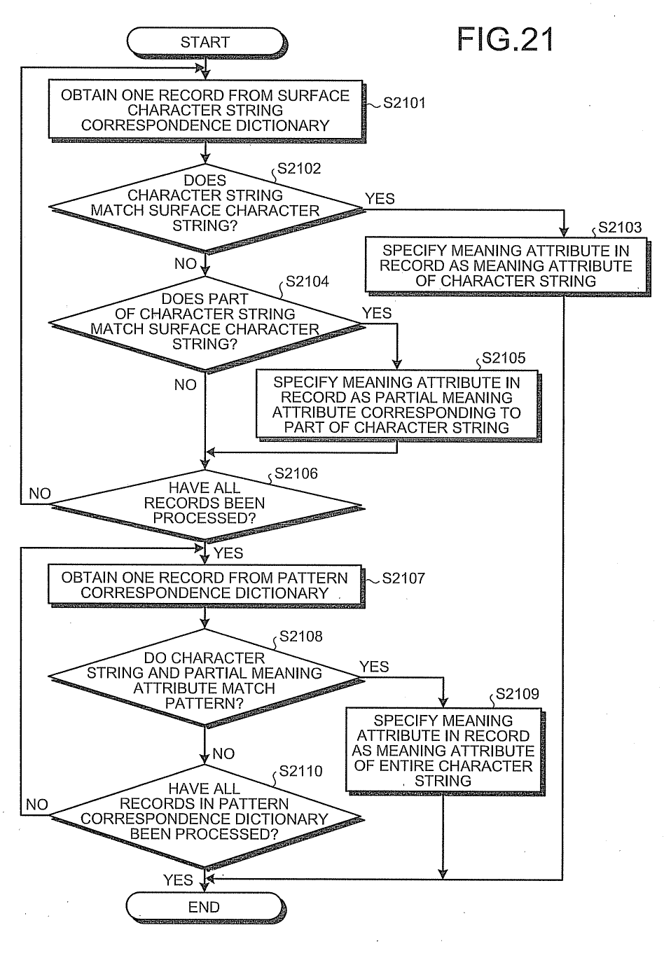

Next, the procedure performed by the information search supporting apparatus 100 according to the first embodiment at step S2007 shown in FIG. 20, to obtain the meaning attributes will be explained with reference to FIG. 21. It is acceptable to use one of existing named entity extraction methods to determine the meaning attributes.

First, the surface character string judging unit 141 obtains one of the records in which a surface character string is associated with a meaning attribute, out of the surface character string correspondence dictionary 102 (step S2101).

After that, the surface character string judging unit 141 judges whether the surface character string in the obtained record matches the character string that has been input by the user (step S2102).

In the case where the surface character string judging unit 141 has judged in the affirmative (step S2102: Yes), the surface character string judging unit 141 specifies the meaning attribute in the record as the meaning attribute of the character string, and the process is ended (step S2103). For example, in the case where the input character string is “Sato”, and the surface character string judging unit 141 has obtained a record in which the surface character string “Sato” is associated with the meaning attribute “Person's Name” out of the surface character string correspondence dictionary 102, the surface character string judging unit 141 judges that the surface character string in the record matches the input character string. Accordingly, the meaning attribute “Person's Name” is specified as the meaning attribute of the character string.

On the contrary, in the case where the surface character string judging unit 141 has judged in the negative (step S2102: No), the surface character string judging unit 141 judges whether a part of the character string matches the surface character string in the obtained record (step S2104). In the case where the surface character string judging unit 141 has judged in the negative (step S2104: No), no particular process is performed. On the contrary, in the case where the surface character string judging unit 141 has judged in the affirmative (step S2104: Yes), the surface character string judging unit 141 specifies the meaning attribute in the record as a partial meaning attribute that corresponds to the part of the character string (step S2105).

In the case where the character string represents one word, the character string may match a single keyword contained in one of the records in the surface character string correspondence dictionary 102; however, in the case where the character string represents a compound word that is made up of a plurality of words, the character string may correspond to a plurality of keywords contained in a plurality of records.

After that, the surface character string judging unit 141 judges whether all the records in the surface character string correspondence dictionary 102 have been processed (step S2106). In the case where the surface character string judging unit 141 has judged that not all the records have been processed (step S2106: No), the process is started again from step S2101.

On the contrary, in the case where the surface character string judging unit 141 has judged that all the records have been processed (step S2106: Yes), the pattern judging unit 142 obtains one of the records from the pattern correspondence dictionary 103 (step S2107).

After that, the pattern judging unit 142 judges whether the character string and the partial meaning attribute specified for the character string match the pattern (step S2108). In the case where the pattern judging unit 142 has judged in the affirmative (step S2108: Yes), the pattern judging unit 142 specifies the meaning attribute in the record as the meaning attribute of the entire character string, and the process is ended (step S2109).

On the contrary, in the case where the pattern judging unit 142 has judged in the negative (step S2108: No), the pattern judging unit 142 judges whether all the records in the pattern correspondence dictionary 103 have been processed (step S2110). In the case where the pattern judging unit 142 has judged that not all the records have been processed (step S2110: No), the process is started again from step S2107.

On the contrary, in the case where the pattern judging unit 142 has judged that all the records have been processed (step S2110: Yes), the process is ended.

In the case where the user has input a plurality of character strings, the processing procedure described above is performed for each of the input character strings. As a result, it is possible to determine the meaning attribute of each of all the character strings.

To determine the meaning attributes, the method is not limited to the one by which the meaning attribute is determined for each input character string. For example, it is acceptable to determine, in advance, meaning attributes for an entire document that is stored and to bring character strings and the meaning attributes thereof into correspondence with one another, so that, when the user has selected a character string from the document, the meaning attribute that is associated with the selected character string is obtained.

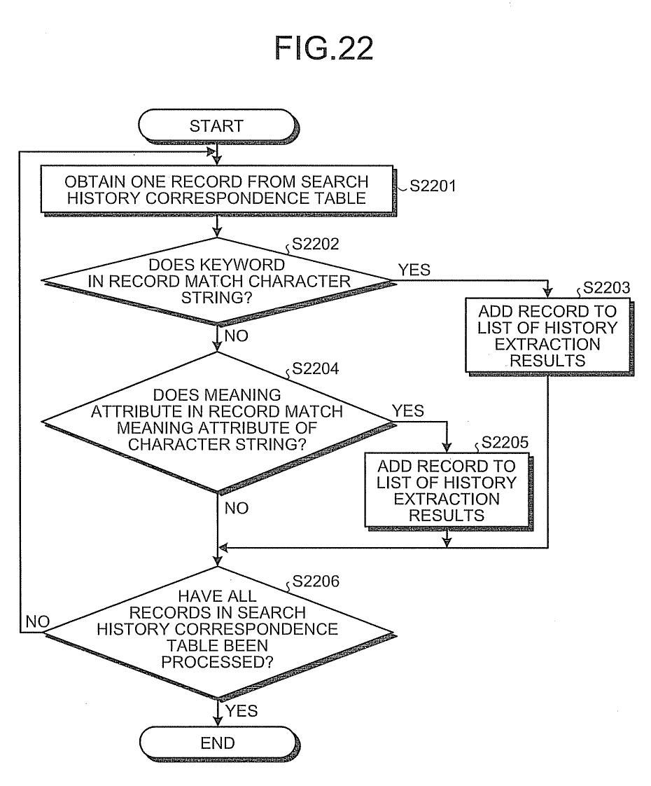

Next, the procedure performed by the information search supporting apparatus 100 according to the first embodiment at step S2008 in FIG. 20, to obtain the list of history extraction results will be explained with reference to FIG. 22.

First, the history obtaining unit 107 obtains one of the records from the search history correspondence table 123 (step S2201).

Next, the history obtaining unit 107 judges whether the keyword in the obtained record matches the character string that has been input by the user (step S2202). In the case where the history obtaining unit 107 has judged in the affirmative (step S2202: Yes), the history obtaining unit 107 adds the record to the list of history extraction results corresponding to the character string (step S2203). It is assumed that the character string input by the user has already been normalized, as explained in the processing procedure shown in FIG. 20.

On the other hand, in the case where the history obtaining unit 107 has judged that the keyword in the obtained record does not match the character string that has been input by the user (step S2202: No), the history obtaining unit 107 judges whether the meaning attribute in the record matches the meaning attribute of the character string (step S2204). In the case where the history obtaining unit 107 has judged in the negative (step S2204: No), no particular process is performed. On the contrary, in the case where the history obtaining unit 107 has judged in the affirmative (step S2204: Yes), the history obtaining unit 107 adds the record to the list of history extraction results corresponding to the meaning attribute (step S2205).

After that, the history obtaining unit 107 judges whether all the records in the search history correspondence table 123 have been processed (step S2206). In the case where the history obtaining unit 107 has judged that not all the records have been processed (step S2206: No), the process is started again from step S2201.

On the contrary, in the case where the history obtaining unit 107 has judged that all the records have been processed (step S2206: Yes), the process is ended.

In the case where the user has input a plurality of character strings, the processing procedure described above is performed for each of the character strings. As a result, it is possible to obtain the lists of history extraction results that correspond to the character strings and the meaning attributes of the character strings, respectively.

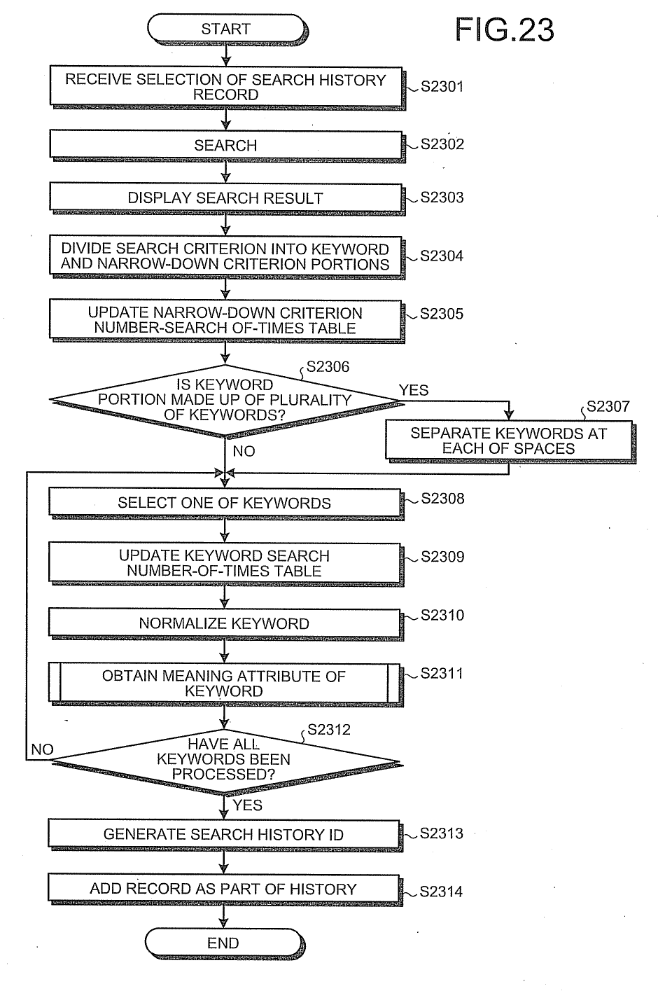

Next, a processing procedure performed by the information search supporting apparatus 100 according to the first embodiment when a search is conducted will be explained, with reference to FIG. 23.

First, it is assumed that the selection receiving unit 109 has received a user's selection of a search history record that has been selected on a search result screen (step S2301). As a result, a set of narrow-down criteria and the like have been specified.

After that, according to an instruction from the user, the searching unit 113 conducts a search by using the search criteria specified by the user (Step S2302). It is assumed that the search criteria include the one or more character strings that have been input as the keywords by the user, the set of narrow-down criteria, and the like.

Next, the displaying unit 105 displays a result of the search conducted by the searching unit 113 (step S2303).

After that, the history table updating unit 114 divides the search criteria into a keyword portion and a narrow-down criterion portion (step S2304). Subsequently, the search number-of-times updating unit 115 updates the narrow-down criterion search number-of-times table 122 by incrementing the search number of times corresponding to the set of narrow-down criteria in the narrow-down criterion portion by “1” (step S2305).

After that, the history table updating unit 114 judges whether the keyword portion is made up of a plurality of keywords (step S2306). In the case where the history table updating unit 114 has judged that the keyword portion is made up of a plurality of keywords (step S2306: Yes), the history table updating unit 114 separates the keywords at each of the spaces (step S2307).

The history table updating unit 114 normally separates keywords at each of spaces (i.e., one-byte spaces and two-byte spaces); however, in the case where two or more keywords are placed between double quotation marks (“ ”) or single quotation marks (‘ ’), the history table updating unit 114 treats the set of keywords as one keyword and does not separate it.

After that, the history table updating unit 114 selects one of the keywords (step S2308). Subsequently, the search number-of-times updating unit 115 updates the keyword search number-of-times table 121 by incrementing the search number of times corresponding to keyword by “1” (step S2309).

The history table updating unit 114 performs the normalizing process on the selected keyword (step S2310). This normalizing process is the same as the normalizing process described above. Thus, the explanation thereof will be omitted.

After that, the attribute obtaining unit 106 obtains the meaning attribute of the keyword according to an instruction from the history table updating unit 114 (step S2311). This meaning attribute obtaining process is performed by using the processing procedure shown in FIG. 21. Thus, the explanation thereof will be omitted.

After that, the history table updating unit 114 judges whether all the keywords have been processed (step S2312). In the case where the history table updating unit 114 has judged that not all the keywords have been processed (step S2312: No), the process is started again from step S2308.

On the contrary, in the case where the history table updating unit 114 has judged that all the keywords have been processed (step S2312: Yes), the history table updating unit 114 generates a search history ID assigned to a record to be added (step S2313).

After that, the history table updating unit 114 adds the record in which the generated search history ID, the keyword, the meaning attribute corresponding to the keyword, and the set of narrow-down criteria are associated with one another, to the search history correspondence table 123 (step S2314).

As explained above, the information search supporting apparatus 100 according to the first embodiment is able to present the history records of the searches conducted in the past after rearranging them in an appropriate order, according to the tendency of the searches conducted by the user. As a result, the user is able to conduct a search with the appropriate search criteria, by inputting one or more character strings and simply selecting any of the sets of narrow-down criteria, for the search criteria. Consequently, there is no need for the user to input appropriate narrow-down criteria, and it is therefore possible to reduce the load on the user caused by the operations. Further, because the search history records are presented, the user is able to easily identify the appropriate narrow-down criteria.

The present invention is not limited to the first embodiment described above. It is possible to apply various modifications as described below to the first embodiment.

In the first embodiment described above, the information search supporting apparatus 100 rearranges the search history records based on the search numbers of times. According to a modification example of the first embodiment, the search history records are rearranged based on the search numbers of times within the past month.

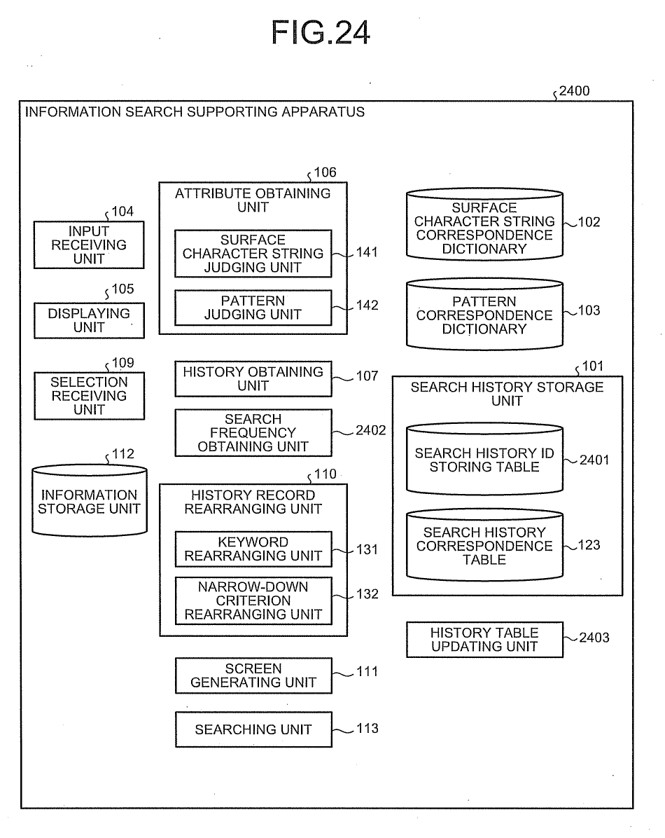

As shown in FIG. 24, an information search supporting apparatus 2400 according to the modification example of the first embodiment is different from the information search supporting apparatus 100 according to the first embodiment in that the keyword search number-of-times table 121, the narrow-down criterion search number-of-times table 122, the search number-of-times updating unit 115, and the search number-of-times obtaining unit 108 are not included, while a search history ID storing table 2401 and a search frequency obtaining unit 2402 are added, and the history table updating unit 114 is changed to a history table updating unit 2403 that performs a different process. In the explanation below, some of the constituent elements that are the same as those according to the first embodiment will be referred to by using the same reference characters, and the explanation thereof will be omitted.

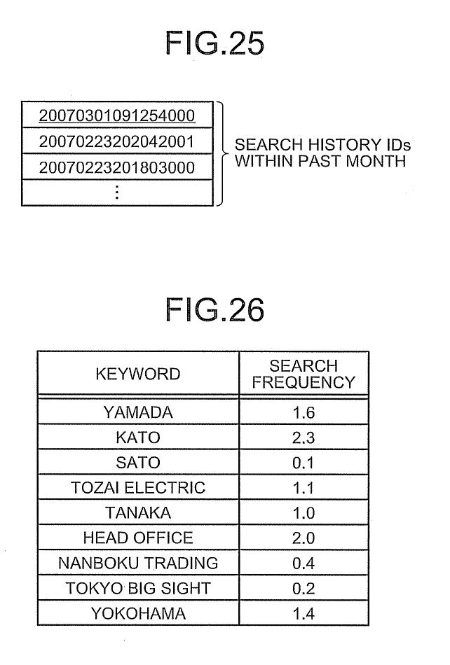

As shown in FIG. 25, the search history ID storing table 2401 stores therein search history IDs that have been used in the searches conducted within the past month.

The search frequency obtaining unit 2402 obtains search frequency levels corresponding to the keywords and the sets of narrow-down criteria, based on the search history correspondence table 123 and the search history ID storing table 2401.

As shown in FIG. 26, the search frequency obtaining unit 2402 calculates the search frequency level corresponding to each of the keywords, based on the keywords that are associated with the search history IDs that have been used within the past month in the search history correspondence table 123. In addition, the search frequency obtaining unit 2402 also calculates the search frequency levels within the last month corresponding to the sets of narrow-down criteria.

After that, the history record rearranging unit 110 rearranges the records for each of the keywords or each of the sets of narrow-down criteria, based on the calculated search frequency levels. The rearranging process is the same as the one performed in the first embodiment. Thus, the explanation thereof will be omitted.

Every time a search is conducted, the history table updating unit 2403 performs the updating process not only on the search history correspondence table 123, but also on the search history ID storing table 2401. More specifically, the history table updating unit 2403 adds the search history ID in the record that has been added to the search history correspondence table 123, to the beginning of the search history ID storing table 2401. With this arrangement, the search history ID storing table 2401 shows the most recent search history ID at the beginning and the oldest search history ID at the end.

Further, the history table updating unit 2403 deletes any of the search history IDs that were added more than one month ago. More specifically, the history table updating unit 2403 sequentially checks the search history IDs starting from the end of the search history ID storing table 2401 and discards any search history record that is more than one month old. The history table updating unit 2403 is able to identify the date of each of the search history IDs by referring to the search history correspondence table 123. With this arrangement, the search frequency levels are calculated always based on the search history records from the past month.

As a result of the processing procedure described above, the information search supporting apparatus 2400 is able to have the tendency of the searches that have most recently been conducted by the user reflected in the presenting of the search history records. Further, the information search supporting apparatus 2400 is especially effective in the case where the tendency of the searches conducted by the user changes over the course of time.

In the explanation above, one month is used as the predetermined period of time for which the search frequency levels are calculated. However, the present invention is not limited to the example in which the search frequency levels are calculated for the past month. Another arrangement is acceptable in which the user is allowed to specify any period of time. Yet another arrangement is acceptable in which the period of time is changed, as necessary, according to the number of times the user conducts a search. For example, in the case where the number of times the user has conducted a search within one month is smaller than a predetermined value, it is possible to improve the level of precision of the search frequency levels by making the period of time for which the search frequency levels are calculated longer.

According to the first embodiment, when the user has input a plurality of character strings, the records are added to the search history correspondence table 123 as the search history records, for each of the character strings. Unlike the first embodiment, according to a second embodiment, a set made up of the plurality of character strings is added as one record to a search history correspondence table 2702.

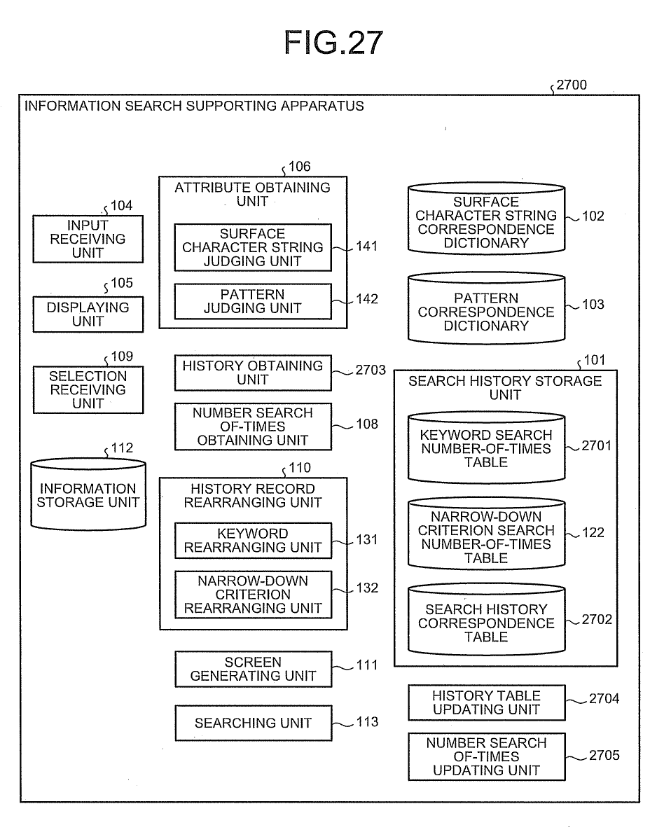

As shown in FIG. 27, an information search supporting apparatus 2700 according to the second embodiment is different from the information search supporting apparatus 100 according to the first embodiment in that it includes: a keyword search number-of-times table 2701 that stores data therein in a format that is different from the data stored in the keyword search number-of-times table 121; a search history correspondence table 2702 that stores data therein in a format that is different from the data stored in the search history correspondence table 123; a history obtaining unit 2703 that performs a process different from the process performed by the history obtaining unit 107; a history table updating unit 2704 that performs a process different from the process performed by the history table updating unit 114; and a search number-of-times updating unit 2705 that performs a process different from the process performed by the search number-of-times updating unit 115. Explanation of some of the constituent elements of the information search supporting apparatus 2700 according to the second embodiment that are the same as those included in the information search supporting apparatus 100 according to the first embodiment will be omitted.

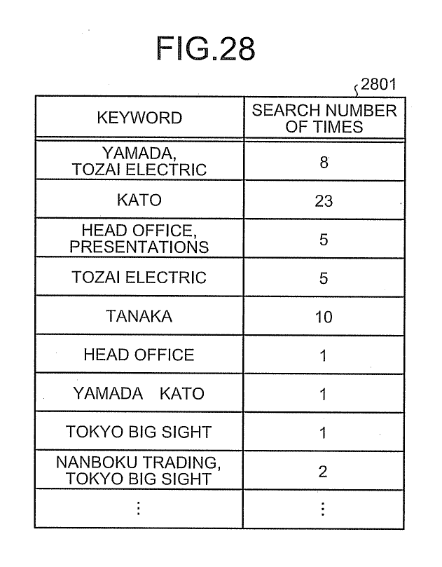

As shown in FIG. 28, the keyword search number-of-times table 2701 is also able to store, in each of the keyword fields, a plurality of keywords, rather than only a single keyword. For example, as shown in a record indicated with the reference character 2801, the keyword search number-of-times table 2701 is able to store, in each of the keyword fields, a set made up of a plurality of keywords such as “Yamada, Tozai Electric”.

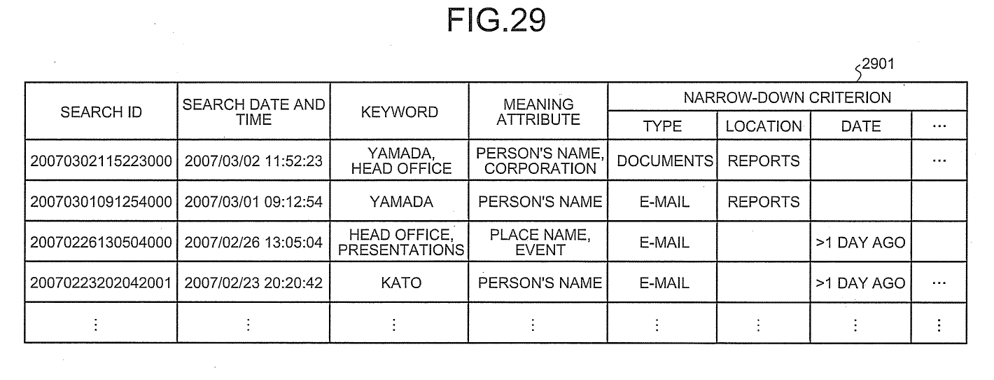

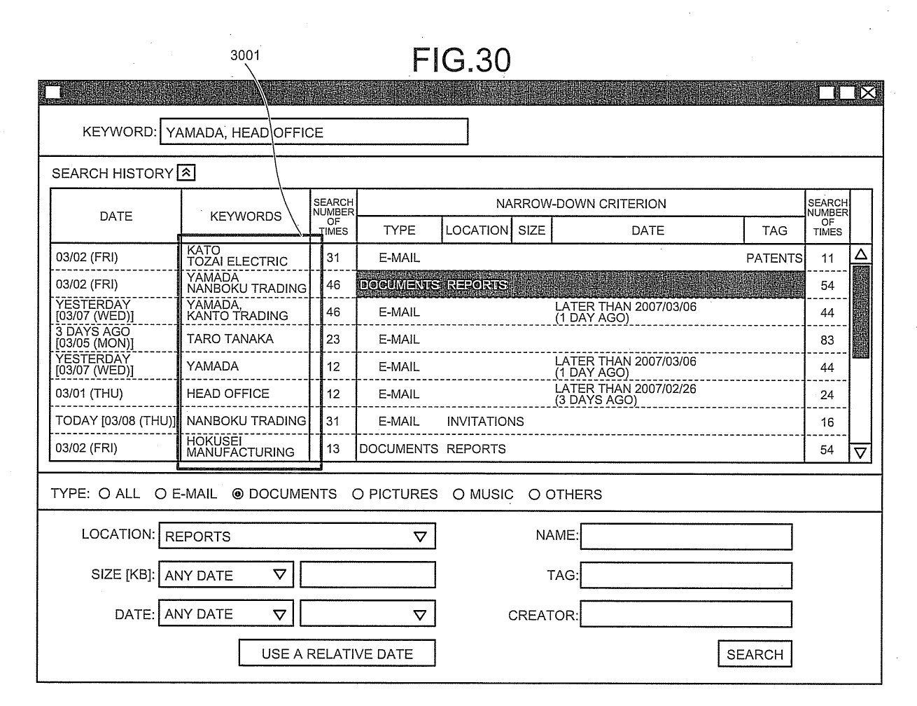

As shown in FIG. 29, the search history correspondence table 2702 is also able to store, in each of the keyword fields, a plurality of keywords, rather only a single keyword. For example, as shown in a record indicated with a record 2901, the search history correspondence table 2702 is able to store, in each of the keyword fields, a set made up of a plurality of keywords such as “Yamada, Head Office”. In the case where the user has input a plurality of keywords as shown in the record 2901 in FIG. 29, the plurality of keywords input by the user is stored in the keyword field. A set made up of the meaning attributes respectively corresponding to the keywords is stored in the meaning attribute field corresponding to the set of keywords.

The history obtaining unit 2703 obtains a list of history extraction results based on the character strings that have been input by the user. The processing procedure will be explained in detail later.

After that, the history record rearranging unit 110 rearranges the list of history extraction results obtained by the history obtaining unit 2703. Subsequently, according to the result of the rearranging process, the screen generating unit 111 generates a search screen.

As shown in an example of the screen in FIG. 30, in a keyword column 3001 in the search history, one or more keywords that match any of the plurality of keywords input by the user and the meaning attributes of the input keywords are displayed.

The history table updating unit 2704 adds the search criteria to the search history correspondence table 2702, as a search history record. Even if the user has input a plurality of character strings as the keywords, the history table updating unit 2704 adds only one record to the search history correspondence table 2702 according to the second embodiment.

The search number-of-times updating unit 2705 updates the keyword search number-of-times table 2701 by incrementing the search number of times corresponding to the set of keywords (or the single keyword) input by the user by “1”. More specifically, even if the user has input a plurality of keywords, the search number-of-times updating unit 2705 increments only the search number of times corresponding to the set of keywords by “1”.

The search number-of-times updating unit 2705 also updates the narrow-down criterion search number-of-times table 122, by incrementing the search number of times corresponding to the set of narrow-down criteria selected by the user by “1”.

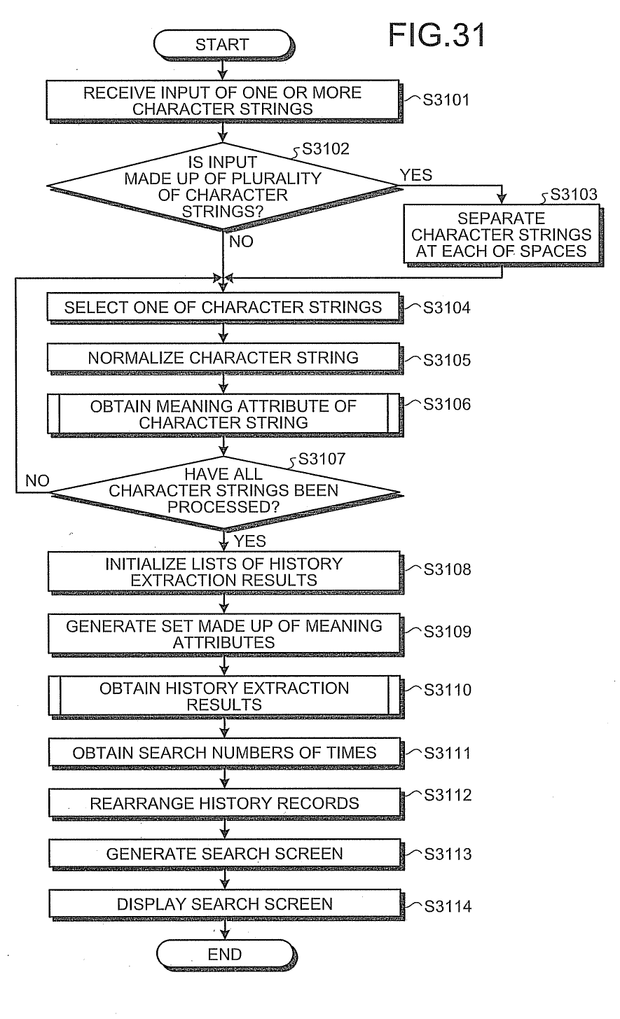

Next, a processing procedure performed by the information search supporting apparatus 2700 according to the second embodiment, up to a process in which a search screen containing search history records is generated and displayed, will be explained with reference to FIG. 31.

First, in the same manner as at steps S2001 through S2005 shown in FIG. 20, the processing procedure is performed up to the process in which the character string is normalized (steps S3101 through S3105).

After that, the attribute obtaining unit 106 obtains the meaning attribute of the character string that has been normalized (step S3106). The method used for obtaining the meaning attributes is the same as the one used in the first embodiment. Thus, the explanation thereof will be omitted.

Subsequently, the attribute obtaining unit 106 and the history obtaining unit 2703 judge whether all the characters have been processed (step S3107). In the case where the attribute obtaining unit 106 and the history obtaining unit 2703 have judged that not all the character strings have been processed (step S3107: No), the process is started again from step S3104.

In the case where the attribute obtaining unit 106 and the history obtaining unit 2703 have judged that all the character strings have been processed (step S3107: Yes), the attribute obtaining unit 106 initializes the lists of history extraction results corresponding to the character strings (step S3108).

After that, the history obtaining unit 2703 generates a set made up of the meaning attributes corresponding to the plurality of characters that have been input by the user (step S3109).

Subsequently, the history obtaining unit 2703 performs the process to obtain history extraction results (step S3110). The processing procedure will be explained in detail later. Each of the history extraction results stores therein the search date, one or more keywords, the search number of times corresponding to the one or more keywords, a set of narrow-down criteria, and the search umber of times corresponding to the set of narrow-down criterion, in association with each other in the form of a list of history extraction results.

The search number-of-times obtaining unit 108 obtains the search numbers of times corresponding to the keywords and the sets of narrow-down criteria contained in the list of history extraction results, out of the keyword search number-of-times table 2701 and the narrow-down criterion search number-of-times table 122 (step S3111).

After that, the history record rearranging unit 110 rearranges the order in which the history records contained in the list of history extraction results are positioned, according to the search numbers of times, for each of the character strings and the meaning attributes (step S3112).

Subsequently, the screen generating unit 111 generates a search screen that contains the search history records that have been rearranged at step S3112 (step S3113).

After that, the displaying unit 105 displays the generated search screen (step S3114). As a result, a search screen as the one shown in FIG. 30 is displayed.

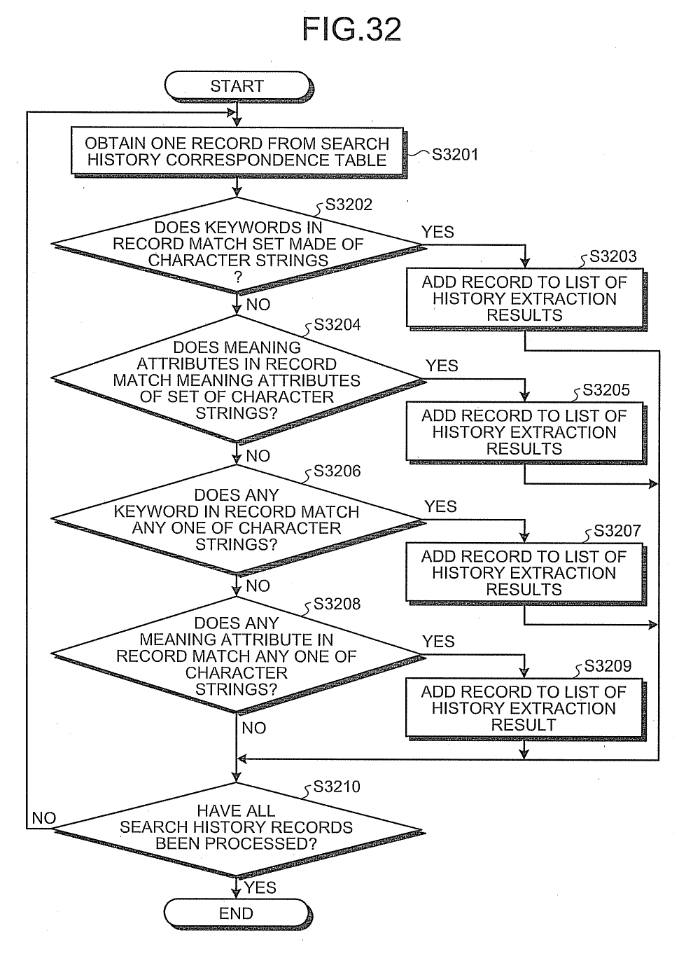

Next, a processing procedure performed by the information search supporting apparatus 2700 according to the second embodiment at step S3110 in FIG. 31 to obtain the history extraction results will be explained, with reference to FIG. 32. In the case where the user has input a plurality of keywords, the information search supporting apparatus 2700 according to the second embodiment extracts the search history records by using the plurality of keywords and the set of meaning attributes corresponding to the keywords.

First, the history obtaining unit 2703 obtains one of the records from the search history correspondence table 2702 (step S3201).

After that, the history obtaining unit 2703 judges whether the keywords in the obtained record match the set made up of the plurality of character strings input by the user (step S3202). In the case where the history obtaining unit 2703 has judged in the affirmative (step S3202: Yes), the history obtaining unit 2703 adds the record to a list of history extraction results corresponding to the set of character strings (step S3203).

On the contrary, in the case where the history obtaining unit 2703 has judged that the keywords in the obtained record do not match the set of character strings input by the user (step S3202: No), the history obtaining unit 2703 judges whether the meaning attributes in the record match the set of meaning attributes that have been obtained based on the plurality of character strings input by the user (step S3204). In the case where the history obtaining unit 2703 has judged in the affirmative (step S3204: Yes), the history obtaining unit 2703 adds the record to a list of history extraction results corresponding to the set of meaning attributes (step S3205).

On the contrary, in the case where the history obtaining unit 2703 has judged that the meaning attributes in the record do not match the set of meaning attributes obtained based on the plurality of character strings input by the user (step S3204: No), the history obtaining unit 2703 judges whether any of the keywords in the record matches any one of the plurality of character strings input by the user (step S3206). In the case where the history obtaining unit 2703 has judged in the affirmative (step S3206: Yes), the history obtaining unit 2703 adds the record to a list of history extraction results corresponding to the one character string (step S3207).

On the contrary, in the case where the history obtaining unit 2703 has judged that none of the keywords in the obtained record matches any of the plurality of character strings input by the user (step S3206: No), the history obtaining unit 2703 judges whether any of the meaning attributes in the record matches the meaning attribute of any one of the plurality of character strings input by the user (step S3208). In the case where the history obtaining unit 2703 has judged in the affirmative (step S3208: Yes), the history obtaining unit 2703 adds the record to a list of history extraction result corresponding to the meaning attribute of the one character string (step S3209).

After that, the history obtaining unit 2703 judges whether all the records in the search history correspondence table 2702 have been processed (step S3210). In the case where the history obtaining unit 2703 has judged that not all the records have been processed (step S3210: No), the process is started again from step S3201.

On the contrary, in the case where the history obtaining unit 2703 has judged that all the records have been processed (step S3210: Yes), the history extraction result obtaining process is ended.

As a result of the processing procedure described above, it is possible to obtain the search history records that are to be used in the display. For example, in the case where search history records corresponding to a plurality of character strings such as “Yamada, Tozai Electric” need to be extracted, in addition to search history records corresponding to each of the keywords (i.e., “Yamada” and “Tozai Electric”), the history obtaining unit 2703 also obtains a search history record that contains “Yamada, Tozai Electric” as a set of keywords, as well as a search history record of a search conducted using such a set of keywords (e.g., “Kato, Nanboku Trading”) that has the set of meaning attributes “Person's Name, Corporation”.

Subsequently, the history record rearranging unit 110 assigns priority levels in the following order (starting with the highest): (i) the search history records each of which contains keywords that match the set of plurality of characters; (ii) the search history records each of which contains meaning attributes that match the set of meaning attributes of the plurality of character strings; (iii) the search history records each of which contains a keyword that matches one of the character strings; and (iv) the search history records each of which contains a meaning attribute that matches the meaning attribute of one of the character strings. In each of the groups of search history records above, the history record rearranging unit 110 rearranges the records in an order according to the search numbers of times. As a result, a search screen as shown in FIG. 30 is displayed.

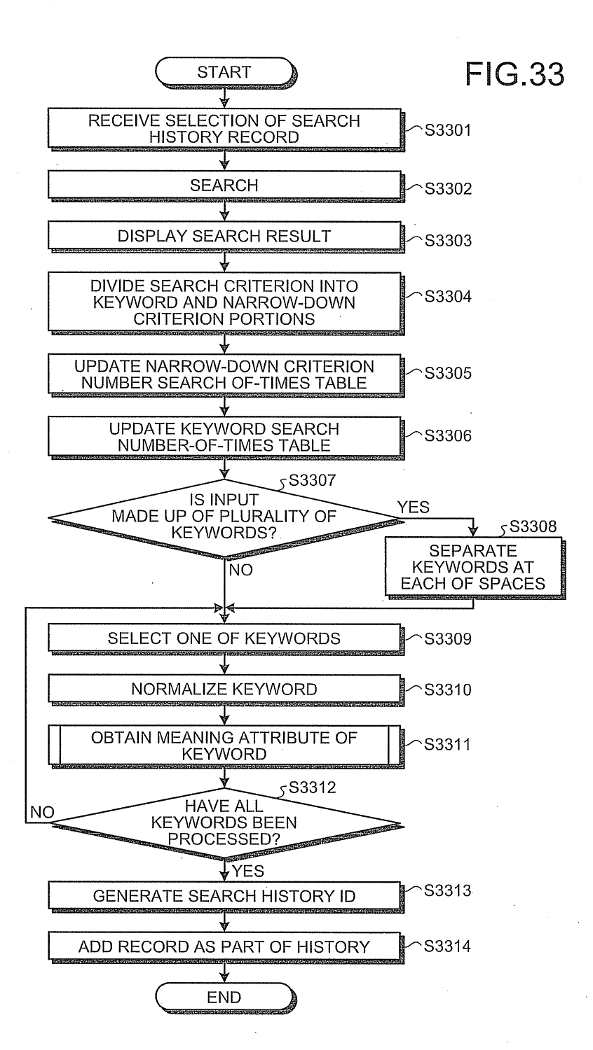

Next, a processing procedure performed by the information search supporting apparatus 2700 according to the second embodiment when a search is conducted will be explained, with reference to FIG. 33.

First, in the same manner as at steps S2301 through S2305 shown in FIG. 23, the processing procedure is performed up to the process in which the narrow-down criterion search number-of-times table 122 is updated with the search number of times corresponding to the set of narrow-down criteria (steps S3301 through S3305).

Next, the search number-of-times updating unit 2705 updates the keyword search number-of-times table 2701 by incrementing, by “1”, the search number of times corresponding to a set of keywords, which is a set made up of the plurality of character strings input by the user (step S3306). For example, in the case where the user has input the character strings “Yamada, Tozai Electric” as the keywords, the search number-of-times updating unit 2705 updates the keyword search number-of-times table 2701 by incrementing the search number of times corresponding to the set “Yamada, Tozai Electric” by “1”.

After that, the history table updating unit 2704 judges whether the input is made up of a plurality of keywords (step S3307). In the case where the history table updating unit 2704 has judged that the input is made up of a plurality of keywords (step S3307: Yes), the history table updating unit 2704 separates the keywords at each of the spaces (step S3308).

After that, the history table updating unit 2704 selects one of the keywords that have been separated (step S3309).

The processes performed thereafter from the normalizing process through the history record storing process are performed in the same manner as the processes at steps S2310 through S2314 shown in FIG. 23 (steps S3310 through S3314).

In the case where the user has input a plurality of character strings, a record in which the search date and time, the set of character strings, the set of meaning attributes corresponding to the character strings, and the set of narrow-down criterion are associated with one another is added. As a result of the processing procedure described above, the search history record is stored.

As explained above, the information search supporting apparatus 2700 according to the second embodiment is able to present the search history records according to the tendency of the searches conducted by the user, with respect to the set of specific keywords. As a result, the user is able to easily specify search narrow-down criteria that are often used together with a set of specific meaning attributes such as “Person's name, Corporation”.

According to a third embodiment, after search history records are displayed on a search screen, the narrow-down criteria on the search screen are displayed in an order according to the search numbers of times.

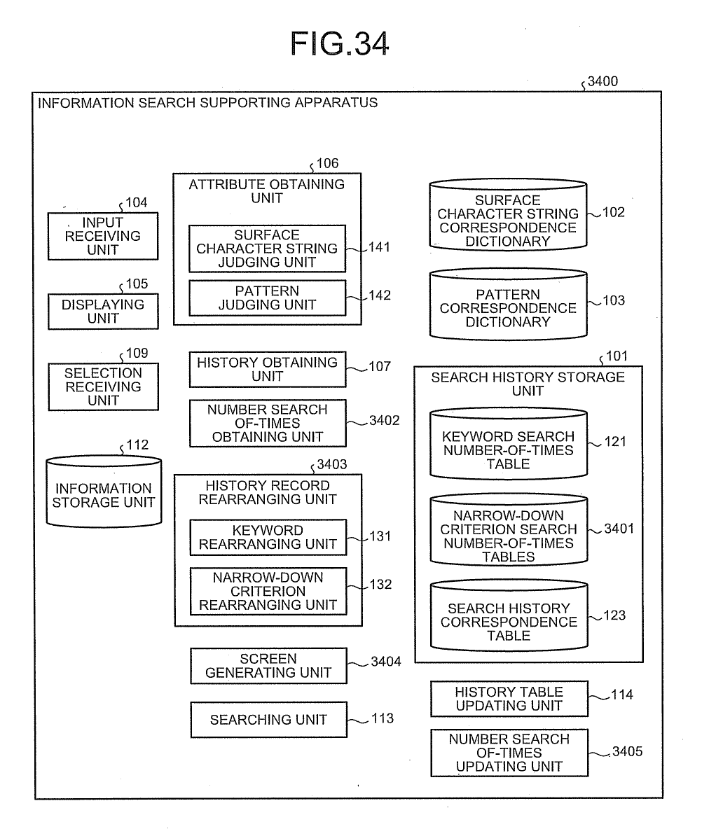

As shown in FIG. 34, an information search supporting apparatus 3400 according to the third embodiment is different from the information search supporting apparatus 100 according to the first embodiment only in that it includes: narrow-down criterion search number-of-times tables 3401 instead of the narrow-down criterion search number-of-times table 122; a search number-of-times obtaining unit 3402 that performs a process different from the process performed by the search number-of-times obtaining unit 108; a history record rearranging unit 3403 that performs a process different from the process performed by the history record rearranging unit 110; a screen generating unit 3404 that performs a process different from the process performed by the screen generating unit 111; and a search number-of-times updating unit 3405 that performs a process different from the process performed by the search number-of-times updating unit 115. Explanation of some of the constituent elements of the information search supporting apparatus 3400 according to the third embodiment that are the same as those included in the information search supporting apparatus 100 according to the first embodiment will be omitted.

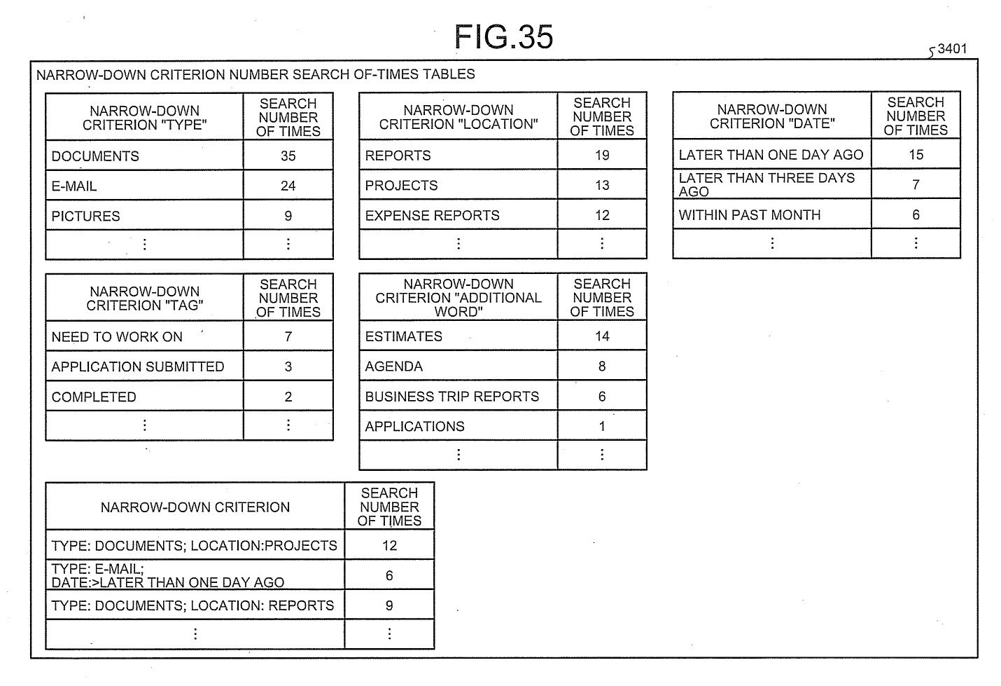

The narrow-down criterion search number-of-times tables 3401 store therein the search numbers of times for each of the different categories of the narrow-down criteria. For example, as shown in FIG. 35, the narrow-down criterion search number-of-times tables 3401 include, in addition to a narrow-down criterion search number-of-times table that is the same as the one according to the first embodiment, a table showing the search numbers of times corresponding to the narrow-down criterion “Type”, a table showing the search numbers of times corresponding to the narrow-down criterion “Date”, a table showing the search numbers of times corresponding to the narrow-down criterion “Location”, and a table showing the search numbers of times corresponding to the narrow-down criterion “Additional Word”. As a result, it is possible to rearrange the order in which the records are positioned according to the search number of times for each of the different categories.

The search number-of-times obtaining unit 3402 obtains the search numbers of times respectively corresponding to the narrow-down criteria obtained by the history obtaining unit 107, out of the narrow-down criterion search number-of-times tables 3401.

The history record rearranging unit 3403 performs the same process as the process performed by the history record rearranging unit 110 according to the first embodiment. In addition, the history record rearranging unit 3403 also rearranges the records based on the search numbers of times for each of the different categories of narrow-down criteria.

The screen generating unit 3404 performs the same process as the process performed by the screen generating unit 111 according to the first embodiment. In addition, the screen generating unit 3404 generates a narrow-down criterion input section for each of the different categories as a combo box, at the bottom of a search screen. In each of the combo boxes, of the narrow-down criteria contained in the search history shown on the search screen, the narrow-down criteria in the corresponding category are positioned in the order rearranged by the history record rearranging unit 3403.

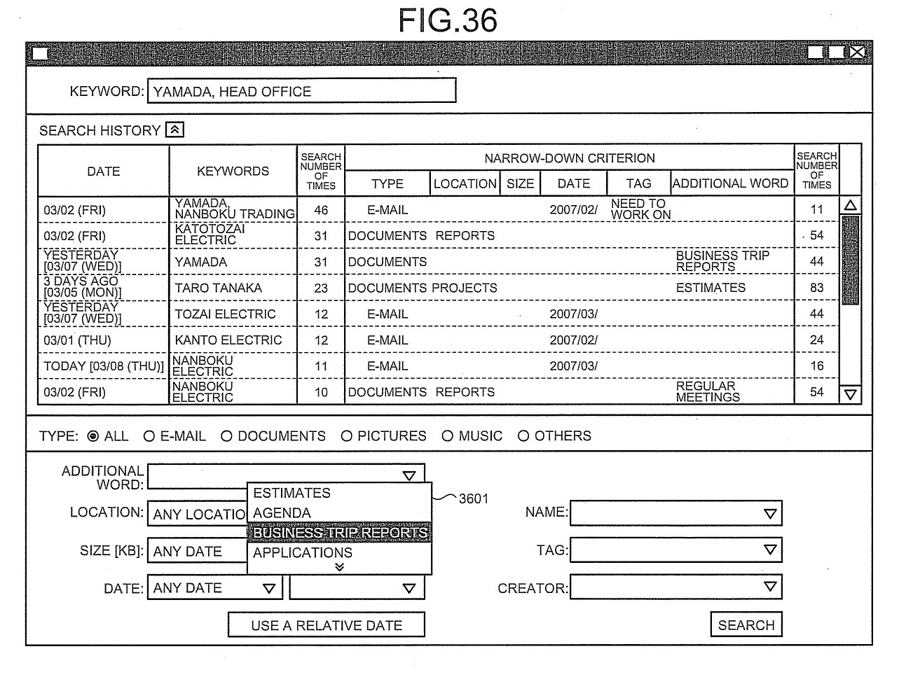

As shown in FIG. 36, on the search screen generated by the screen generating unit 3404, when a selection is made in a combo box 3601, the additional words contained in the search history records are displayed after being rearranged in the order according to the search number of times. With this arrangement, it is possible to allow the user to input an individual narrow-down criterion more easily.

For example, in the case where the user has input character strings “Yamada, Tozai Electric” as the keywords, when the user has pushed the combo box 3601 for the additional words after the list of search history records is displayed, the narrow-down criteria from the category of “Additional Word” are displayed in the order according to the search numbers of times, the narrow-down criteria having been extracted from the search history records corresponding to the keyword “Yamada”, the search history records corresponding to the meaning attribute “Person's Name”, the search history records corresponding to the keyword “Tozai Electric”, and the search history records corresponding to the meaning attribute “Corporation”. With this arrangement, the user is able to specify any of the narrow-down criteria in the category of “Additional Word”, by selecting a desired one of the presented narrow-down criteria.

The search number-of-times updating unit 3405 performs a process to update each of the narrow-down criterion search number-of-times tables 3401.

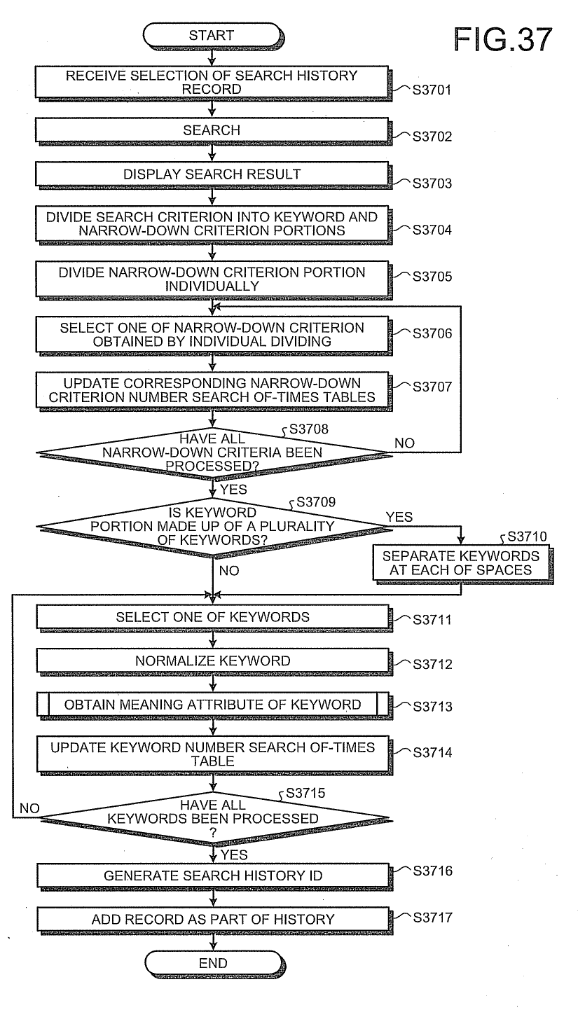

Next, a processing procedure performed by the information search supporting apparatus 3400 according to the third embodiment when a search is conducted will be explained, with reference to FIG. 37.

First, in the same manner as at steps S2301 through S2304 shown in FIG. 23 according to the first embodiment, the search criteria is divided into a keyword portion and a narrow-down criterion portion (steps S3701 through S3704).

Next, the search number-of-times updating unit 3405 further divides the narrow-down criterion portion individually (i.e., in association with the different categories) (step S3705). After that, the search number-of-times updating unit 3405 selects one of the narrow-down criteria obtained by dividing the narrow-down criterion portion individually (i.e., in association with the different categories) (step S3706).

Subsequently, the search number-of-times updating unit 3405 updates the corresponding one of the narrow-down criterion search number-of-times tables by incrementing the search number of times by “1” (step S3707).

After that, the search number-of-times updating unit 3405 judges whether all the narrow-down criteria have been processed (step S3708). In the case where the search number-of-times updating unit 3405 has judged that not all the narrow-down criteria have been processed (step S3708: No), the process is started again from step S3706.

Subsequently, in the same manner as at steps S2306 through S2308 shown in FIG. 23, the processing procedure is performed up to the process in which one of the keywords is selected (steps S3709 through S3711).

The history table updating unit 114 performs the normalizing process on the selected keyword (step S3712). This normalizing process is the same as the normalizing process described above. Thus, the explanation thereof will be omitted.

After that, the attribute obtaining unit 106 obtains the meaning attribute of the keyword according to an instruction from the history table updating unit 114 (step S3713). This meaning attribute obtaining process is performed by using the processing procedure shown in FIG. 21. Thus, the explanation thereof will be omitted.

Subsequently, the history table updating unit 114 updates the keyword search number-of-times table 121 by incrementing the search number of times corresponding to the keyword by “1” (step S3714).

After that, the history table updating unit 114 judges whether all the keywords have been processed (step S3715). In the case where the history table updating unit 114 has judged that not all the keywords have been processed (step S3715: No), the process is started again from step S3711.

On the contrary, in the case where the history table updating unit 114 has judged that all the keywords have been processed (step S3715: Yes), after the same processing procedure as the one shown at steps S2313 through S2314 in FIG. 23 is performed, the process is ended (steps S3716 through S3717).

As explained above, the information search supporting apparatus 3400 according to the third embodiment is able to present the narrow-down criteria in descending order of the search number of times in the narrow-down criterion input section on the search screen. As a result, when inputting a narrow-down criterion individually, the user does not need to perform the operations of inputting character strings and selecting folders. Thus, the information search supporting apparatus 3400 is able to support the user in specifying the criteria in a flexible manner.

In the information search supporting apparatuses according to the first, the second, and the third embodiments described above, the user needs to input one or more character strings that are used as the keywords on a search screen. According to a fourth embodiment, an example in which an information search supporting apparatus supports the user in inputting keywords on the search screen will be explained.

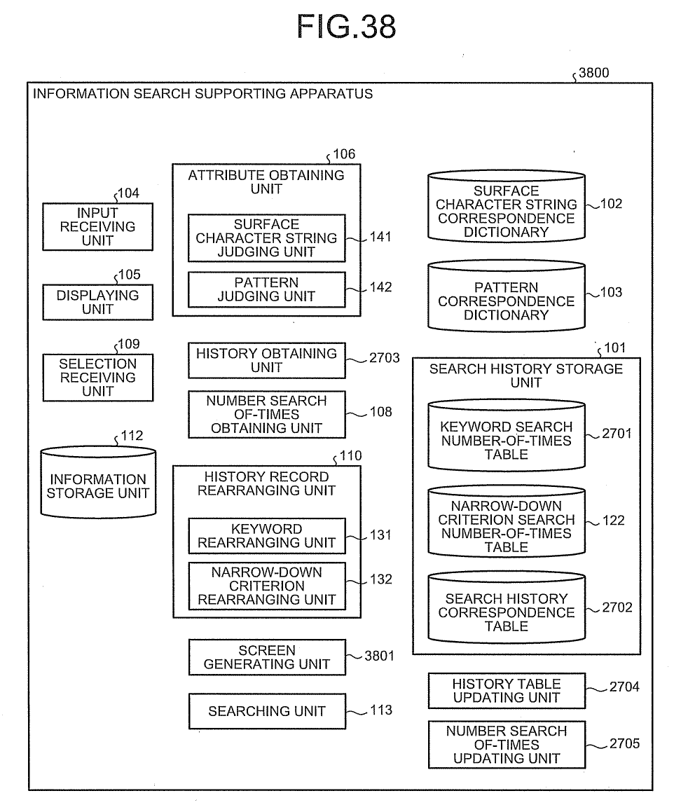

As shown in FIG. 38, the information search supporting apparatus 3800 according to the fourth embodiment is different from the information search supporting apparatus 2700 according to the second embodiment only in that it includes a screen generating unit 3801 that performs a process different from the process performed by the screen generating unit 111. Explanation of some of the constituent elements of the information search supporting apparatus 3800 according to the fourth embodiment that are the same as those included in the information search supporting apparatus 2700 according to the second embodiment will be omitted.

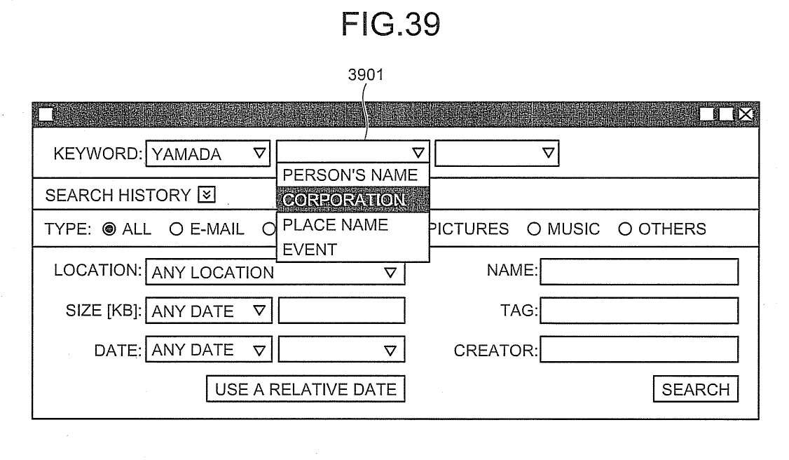

The screen generating unit 3801 generates a keyword input box on a search screen as a combo box. As shown in FIG. 39, the search screen generated by the screen generating unit 3801 allows the user to not only input a character string as a keyword, but also select one of the meaning attributes from a combo box 3901. As a result, the user is able to input a keyword, without having to input a character string.

The combo box 3901 shown in FIG. 39 presents a list of the meaning attributes of the keywords extracted from the search history correspondence table 2702. In the combo box 3901, the meaning attributes such as “Person's Name”, “Place Name”, and “Corporation” are presented.

Next, an operation procedure performed by the user to conduct a search on the search screen will be explained.

First, on the search screen shown in FIG. 39, the user inputs a character string “Yamada” as a keyword, by using a keyboard. After that, the user further selects one of the meaning attributes “Corporation” from the combo box 3901. It is acceptable for the user to directly input a character string “Corporation” by using the keyboard.

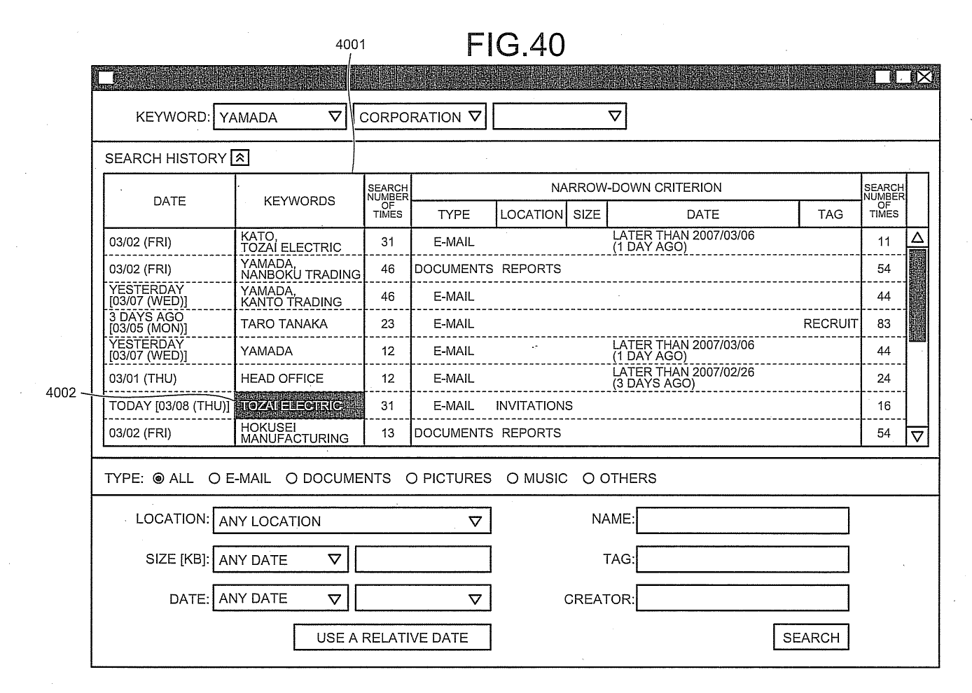

As a result, the information search supporting apparatus 3800 performs the same processes as those in the second embodiment and displays search history records on the search screen as shown in FIG. 40. The displayed search history records include: search history records each containing a set of keywords such as “Yamada, Nanboku Trading” or “Kato, Tozai Electric” that matches the set of meaning attributes “Person's Name, Corporation”; a search history record corresponding to the keyword “Yamada”; a search history record corresponding to the meaning attribute “Person's Name”; and a search history record corresponding to the meaning attribute “Corporation”.

In the example described above, the search history records are extracted by performing the same processes as those according to the second embodiment; however, another arrangement is acceptable in which, like in the first embodiment, the search history records are stored while divided into the groups respectively corresponding to the keywords, so that the search history records are extracted for each of the input keywords and each of the meaning attributes of the keywords.

As for the timing, the search history records may be displayed after the search history display button on the search screen is pushed, like in the first embodiment. Another arrangement is acceptable in which the search history records are displayed after that user has confirmed a Kana-Kanji conversion of an input character string (Note: “Kana” and “Kanji” are types of characters used in Japanese). Yet another arrangement is acceptable in which the search history records are displayed after the user has selected one of the meaning attributes from the combo box.

When the user has selected an arbitrary one of the keywords from a keyword field 4001, out of the list of search history records that have been presented, in the case where the user has input or selected a character string representing a meaning attribute, the screen generating unit 3801 generates a search screen on which with the selected keyword is replaced by a character string portion having a meaning attribute that matches the selected keyword.

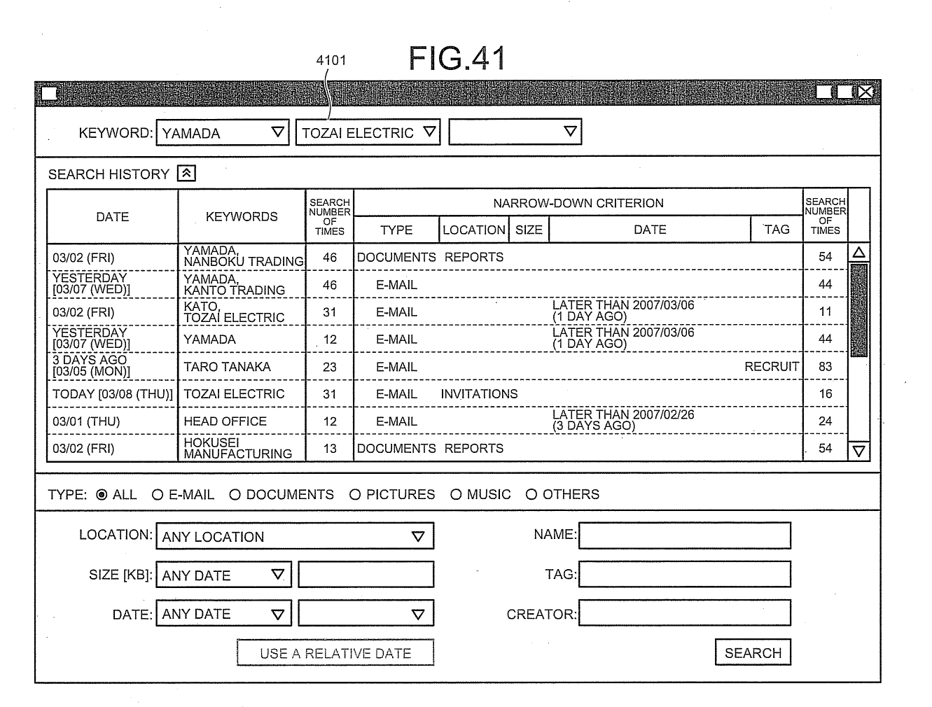

For example, because the user has selected “Tozai Denki” indicated with a reference number 4002 from the list of search history records on the screen shown in FIG. 40, the field in the keyword input box showing “Corporation” in FIG. 40 has been replaced with “Tozai Denki” indicated with a reference character 4101 on the search screen shown in FIG. 41. In addition, every time the user confirmed a keyword, the list of search history records is rearranged according to the search numbers of times.

As explained above, when the user has input or selected a meaning attribute, the information search supporting apparatus 3800 according to the fourth embodiment presents the search history records each of which contains the meaning attribute, in an order that has been rearranged according to the tendency of the searches conducted by the user. After that, when the information search supporting apparatus 3800 has received the user's selection out of the keywords that have been used as search criteria from the search history records, the user is able to confirm the keyword that is to be used as a search criterion.

Thus, even if the user is not able to come up with a keyword that is suitable for the search or the user cannot remember the exact keyword, the user is able to confirm an appropriate keyword based on the meaning attribute or the like.

According to a fifth embodiment, in addition to the configurations of the first and the second embodiments, the user's evaluations of search criteria are stored together with the search history records.

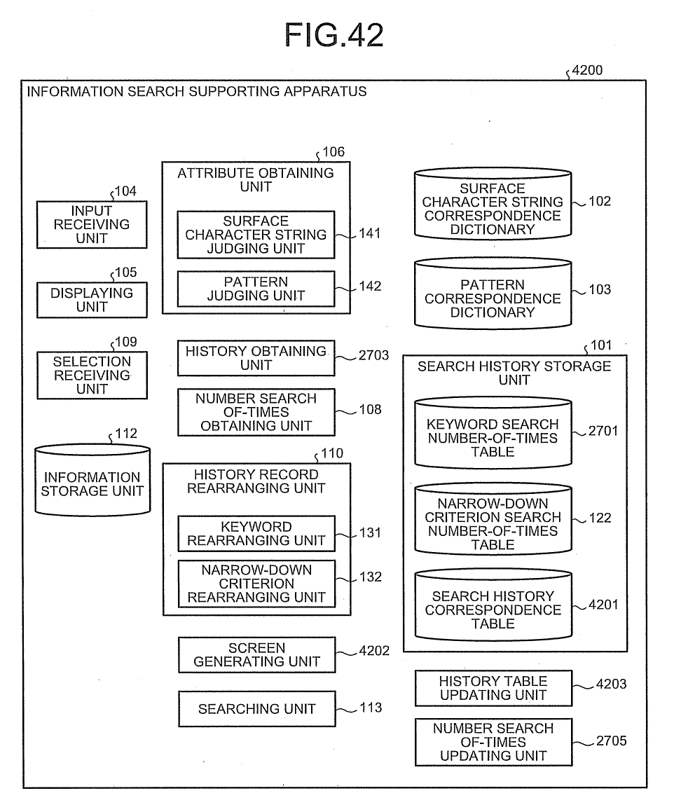

As shown in FIG. 42, an information search supporting apparatus 4200 according to the fifth embodiment is different from the information search supporting apparatus 2700 according to the second embodiment only in that in includes: a search history correspondence table 4201 that has a table structure different from that of the history correspondence table 2702; a screen generating unit 4202 that performs a process different from the process performed by the screen generating unit 111; and a history table updating unit 4203 that performs a process different from the process performed by the history table updating unit 2704. Explanation of some of the constituent elements of the information search supporting apparatus 4200 according to the fifth embodiment that are the same as those included in the information search supporting apparatus 2700 according to the second embodiment will be omitted.

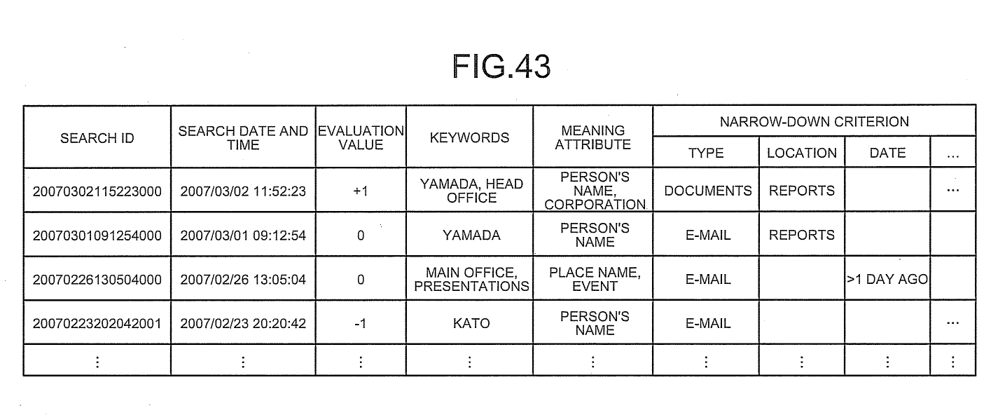

As shown in FIG. 43, in addition to search IDs, search dates and times, keywords, meaning attributes, and sets of narrow-down criteria, the search history correspondence table 4201 further stores therein evaluation values, in association with each other. Each of the evaluation values is a value determined by the user as an evaluation of the corresponding search history record.

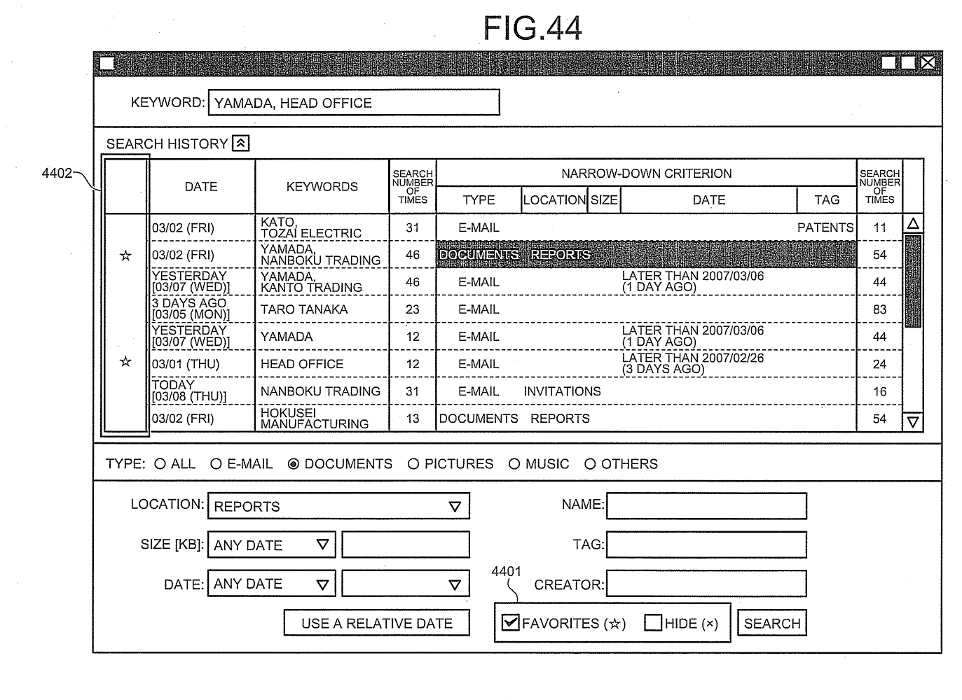

The screen generating unit 4202 generates a search screen that contains the search history records that have been rearranged by the history record rearranging unit 110. On a generated search screen as shown in FIG. 44, in addition to the configurations described in the second embodiment, check boxes 4401 for “Favorites” and “Hide” are displayed.

In the case where the user is satisfied with the search criteria (or the search result) specified on the search screen shown in FIG. 44, and the user predicts that he/she may use them again in the future, the user puts a check in the “Favorites” box. On the contrary, in the case where the user is not satisfied with the search criteria (or the search result), and the user predicts that he/she will not use them in the future and does not wish to have them displayed in the list of search history results, the user puts a check in the “Hide” box.

The history table updating unit 4203 updates the search history records by adding a value representing the check that has been put in by the user. As a result, the search history correspondence table 4201 has stored therein the evaluation value together with the search history records.

For example, in the case where the user has put a check in the “Favorites” box, as shown in FIG. 43, “+1” is stored into the evaluation value field. As another example, in the case where the user has put a check in the “Hide” box, “−1” is stored into the evaluation value field. In other situations, “0” is stored in the evaluation value field. The method used for specifying the evaluation values is not limited to the example described above in which the check boxes are used. For example, another arrangement is acceptable in which the user evaluates the search criteria by giving a grade 1, 2, 3, 4 or 5 that respectively correspond to five different levels.

After that, to each of the search history records to which the evaluation value of “+1” has been assigned, the screen generating unit 4202 adds a symbol indicating that the search history record is the user's “Favorite”, in a leftmost column 4402 of the list of search history records shown on the search screen. Another arrangement is acceptable in which the screen generating unit 4202 gives higher priority to the “Favorite” search history records and arranges them so as to be positioned at the top of the list of search history records.

On the other hand, as for the search history records to each of which the evaluation value of “−1” has been assigned, the screen generating unit 4202 does not show them in the list of search history results on the search screen. Another arrangement is acceptable in which another check box reading “Display search history records including those marked as ‘Hide’” at the bottom of the search screen so that, when the user has puts a check in this check box, the search history records to each of which the evaluation value of “−1” has been assigned are also displayed.

As explained above, the information search supporting apparatus 4200 according to the fifth embodiment filters the search history records in the list based on the evaluation values determined by the user with respect to the search criteria. As a result, the search criteria with which the searches were not successfully conducted will not be displayed in the top section of the list. Thus, an advantageous effect is achieved where it is easier for the user to select appropriate search criteria.

Each of the information search supporting apparatuses according to the first to the fifth embodiments separately displays the window in which the search criteria can be input. An information search supporting apparatus according to a sixth embodiment allows the user to input a keyword by simply selecting a character string in a document and to input one or more narrow-down criteria by selecting an item from a menu.

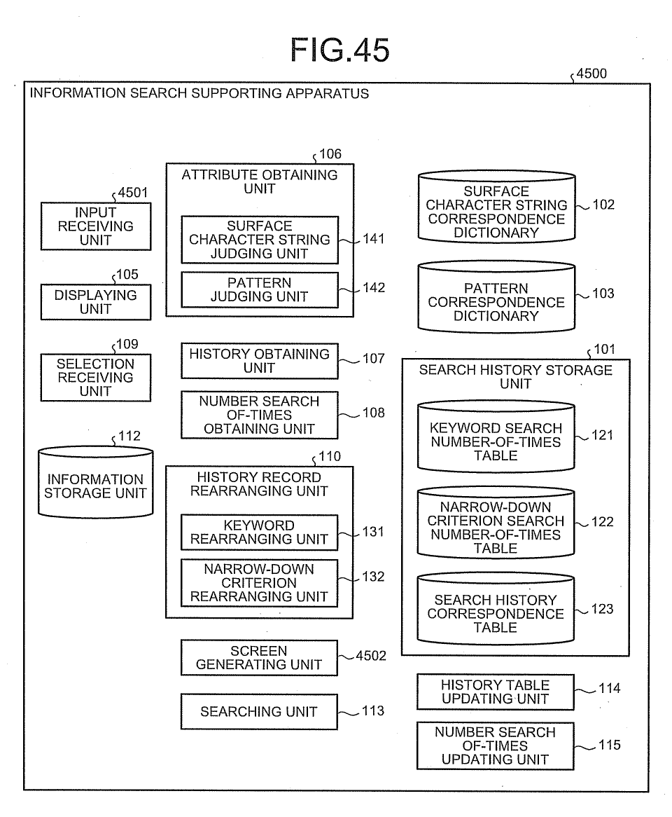

As shown in FIG. 45, an information search supporting apparatus 4500 according to the sixth embodiment is different from the information search supporting apparatus 100 according to the first embodiment only in that it includes an input receiving unit 4501 that performs a process different from the process performed by the input receiving unit 104; and a screen generating unit 4502 that performs a process different from the process performed by the screen generating unit 111. Explanation of some of the constituent elements of the information search supporting apparatus 4500 according to the sixth embodiment that are the same as those included in the information search supporting apparatus 100 according to the first embodiment will be omitted.

The input receiving unit 4501 receives an input of a character string that has been selected by the user on a screen in an Internet browser or in a document browsing application.

The screen generating unit 4502 generates, as a search screen, a menu window that contains only the sets of narrow-down criteria extracted from the search history records that have been rearranged by the history record rearranging unit 110.

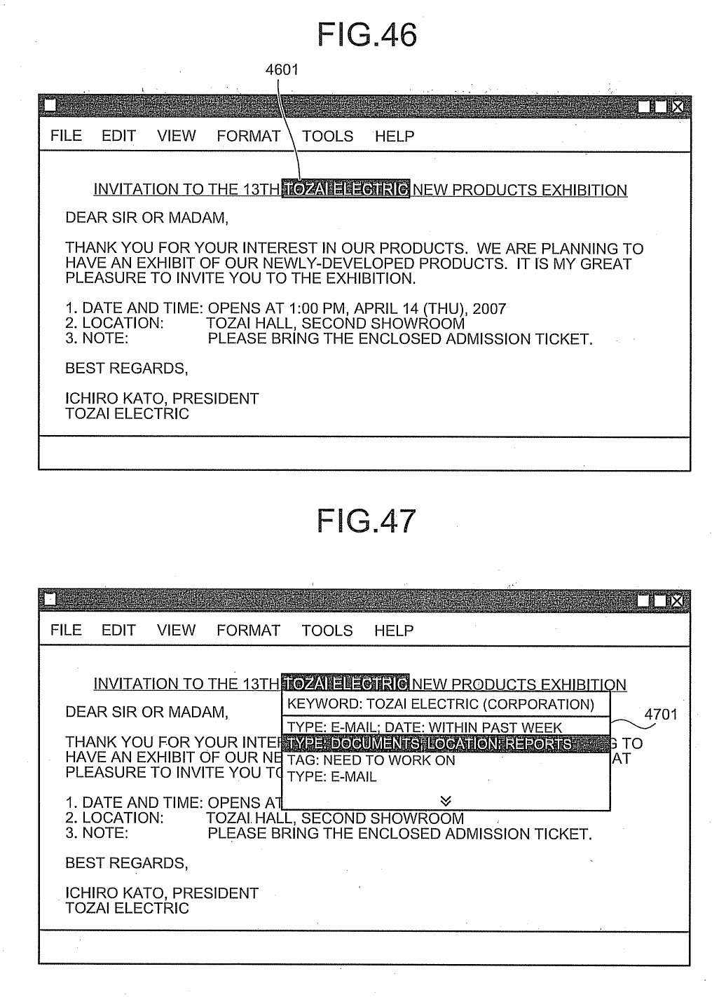

As shown in FIG. 46, in the case where the user has selected a character string 4601 that the user wishes to use in a search, by using a pointing device such as a mouse, on a screen in an Internet browser or in a document browsing application, the input receiving unit 4501 performs the input process on the selected character string.

After that, like in the first embodiment, the search history records are obtained based on the selected character string, and the obtained search history records are rearranged based on the search numbers of times. Subsequently, the screen generating unit 4502 generates a menu that contains only the narrow-down criteria portion of the rearranged search history records.

As shown in FIG. 47, a narrow-down criterion menu 4701 generated by the screen generating unit 4502 presents sets of narrow-down criteria to the user in a selectable manner.

In the case where the user has selected one of the sets of narrow-down criteria from the menu 4701 shown in FIG. 47, the searching unit 113 conducts a search while using the selected set of narrow-down criteria and the selected character string as the search criteria, so that the displaying unit 105 displays a result of the search. Another arrangement is acceptable in which, instead of the result of the search, a search screen on which the selected character string and the selected set of narrow-down criteria are specified.

As explained above, the information search supporting apparatus 4500 according to the sixth embodiment allows the user to select one of the sets of narrow-down criteria that are presented in the menu 4701 that has been obtained by using the character string selected by the user as the keyword. Thus, the user is able to easily specify the search criteria. Consequently, it is possible to reduce the load on the user caused by the operation.

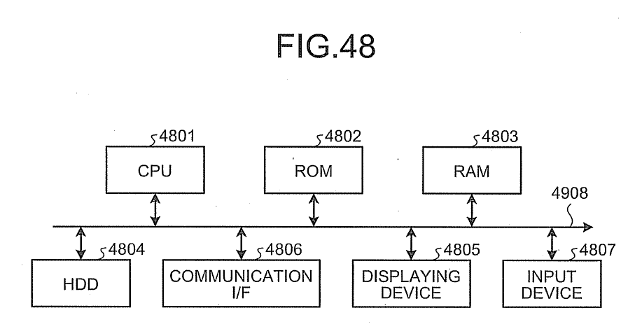

As shown in FIG. 48, each of the information search supporting apparatuses (100, 2400, 3400, 3800, and 4500) according to the exemplary embodiments described above includes, as its hardware configuration, a Read Only Memory (ROM) 4802 that stores therein, for example, an information search computer program that performs the processes described above; a Central Processing Unit (CPU) 4801 that controls the constituent elements of the information search supporting apparatuses (100, 2400, 3400, 3800, or 4500) according to the computer program stored in the ROM 4802; a Random Access Memory (RAM) 4803 that serves as a data storage area; a Hard Disk Drive (HDD) 4804 that stores information therein; a communication interface (I/F) 4806 that establishes a connection to a network and performs communication; an input device 4807; a displaying device 4805; and a bus 4808 that connects these constituent elements to one another.

The information search computer program may be provided as being recorded on a computer-readable recording medium such as a Compact Disc Read-Only Memory (CD-ROM), a floppy (registered trademark) disk (FD), a Digital Versatile Disk (DVD), in a file that is in an installable format or in an executable format.

In that situation, the information search computer program is loaded into the RAM 4803 when being read from the recording medium and executed in each of the information search supporting apparatuses (100, 2400, 3400, 3800, and 4500), so that the constituent elements explained in the description of the software configuration are generated in the RAM 4803.

Another arrangement is acceptable in which the information search computer program according to any of the embodiments described above is stored in a computer that is connected to a network like the Internet so that the information search computer program is provided as being downloaded via the network.

The present invention has been explained through the exemplary embodiments. It should be noted, however, that it is possible to combine any of the configurations in the exemplary embodiments described above, and to apply various modifications and improvements to the exemplary embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information search supporting apparatus comprising:
a search history storage unit that stores keywords that have been used in searches, narrow-down criteria for each of the keywords, and keyword attributes each showing an attribute that expresses a meaning of a corresponding one of the keywords, in association with each other;
a search number-of-times storage unit that stores a search number of times indicating how many times at least one of each keyword and each narrow-down criterion has been used in the searches;
an input receiving unit that receives an input of a character string;
an attribute obtaining unit that obtains, based on the character string, a character string attribute showing an attribute that expresses a meaning of the character string;
a history obtaining unit that obtains, from the search history storage unit, a keyword and a narrow-down criterion for the keyword, which are associated with a keyword attribute that matches the character string attribute;
a search number-of-times obtaining unit that obtains, from the search number-of-times storage unit, the number of times of at least one of the keyword and the narrow-down criterion;
a rearranging unit that rearranges the keywords and the narrow-down criteria, based on the number of times of at least one of the keywords and the narrow-down criteria; and
a screen generating unit that generates a screen for supporting to specify a new search criterion, wherein the keywords and the narrow-down criteria are rearranged by the rearranging unit.

2. The apparatus according to claim 1, wherein the history obtaining unit obtains, from the search history storage unit, a keyword that matches the character string from among the keywords associated with the keyword attribute matching the obtained character string attribute, a narrow-down criterion for the keyword associated with the keyword.

3. The apparatus according to claim 1, further comprising:
a displaying unit that displays the screen generated by the screen generating unit; and
a selection receiving unit that receives a selection of at least one of the narrow-down criteria through the displayed screen.

4. The apparatus according to claim 3, further comprising a searching unit that conducts a search using the at least one of the narrow-down criteria indicated by the selection.

5. The apparatus according to claim 1, wherein
the rearranging unit includes at least one of
a keyword rearranging unit that rearranges the keywords and the narrow-down criteria based on the number of times of the keywords; and
a narrow-down criterion rearranging unit that rearranges the keywords and the narrow-down criteria based on the number of times of the narrow-down criteria.

6. The apparatus according to claim 1, further comprising an attribute storage unit that stores comparison target character strings, each to be compared with the character string, and comparison target character string attributes, each expressing a meaning attribute of a corresponding one of the comparison target character strings, in association with each other, wherein
the attribute obtaining unit obtains, as the character string attribute, one of the comparison target character string attributes associated with one of the comparison target character strings that matches the character string in the attribute storage unit.

7. The apparatus according to claim 3, further comprising:
a history updating unit that updates the search history storage unit by adding the character string and the at least one of the narrow-down criteria indicated by the selection in the search history storage unit so that the character string and the at least one of the narrow-down criteria are associated with each other; and
a search number-of-times updating unit that updates the search number-of-times storage unit by updating the number of times of at least one of (1) the character string and (2) the at least one of the narrow-down criteria indicated by the selection.

8. The apparatus according to claim 7, wherein
the input receiving unit receives a plurality of character strings as the input,
the history updating unit updates the search history storage unit by adding a set made up of the character strings and the at least one of the narrow-down criteria indicated by the selection to the search history storage unit so that the set and the at least one of the narrow-down criteria are associated with each other, and
the search number-of-times updating unit updates the search number-of-times storage unit by updating the number of times corresponding to the set of character strings input by the user.

9. The apparatus according to claim 1, wherein
in a case where the input receiving unit receives a plurality of character strings as the input, one of the character strings is the character string attribute, and
the history obtaining unit obtains, from the search history storage unit, any of the keywords associated with the keyword attributes that respectively match the character string attribute received as the input by the input receiving unit and the character string attribute obtained by the attribute obtaining unit, as well as the narrow-down criteria for each of the keywords.

10. The apparatus according to claim 1, wherein
the search number-of-times storage unit stores the number of times of the narrow-down criteria, for each category of the narrow-down criteria,
the rearranging unit rearranges the narrow-down criteria, based on the number of times of each category of the narrow-down criteria, and
the screen generating unit generates a screen for prompting the user to specify a new search criterion, wherein the narrow-down criteria in each category are displayed in a rearranged order on the screen.

11. An information search supporting method comprising:
storing, in a search history storage unit, keywords that have been used in searches, narrow-down criteria for each of the keywords, and keyword attributes each showing an attribute that expresses a meaning of a corresponding one of the keywords, in association with each other;
storing, in a search number-of-times storage unit, a search number of times indicating how many times at least one of each keyword and each narrow-down criterion has been used in the searches;
receiving an input of a character string;
obtaining, based on the character string, a character string attribute showing an attribute that expresses a meaning of the character string;
obtaining, from the search history storage unit, a keyword and a narrow-down criterion for the keyword, which are associated with a keyword attribute that matches the character string attribute;
obtaining, from the search number-of-times storage unit, the number of times of at least one of the keyword and the narrow-down criterion;
rearranging the keywords and the narrow-down criteria, based on the number of times of at least one of the keywords and the narrow-down criteria; and
generating a screen for supporting to specify a new search criterion, wherein the keywords and the narrow-down criteria are rearranged by the rearranging.

12. The method according to claim 11, wherein the obtaining the keyword and the narrow-down criterion includes obtaining, from the search history storage unit, a keyword that matches the character string from among the keywords associated with the keyword attribute matching the obtained character string attribute, a narrow-down criterion for the keyword associated with the keyword.

13. The method according to claim 11, further comprising:
displaying, on a displaying unit, the screen generated by the generating the screen; and
receiving a selection of at least one of the narrow-down criteria through the displayed screen.

14. The method according to claim 13, further comprising conducting a search using the at least one of the narrow-down criteria indicated by the selection.

15. The method according to claim 11, wherein
the rearranging includes at least one of
rearranging the keywords and the narrow-down criteria based on the number of times of the keywords; and
rearranging the keywords and the narrow-down criteria based on the number of times of the narrow-down criteria.

16. The method according to claim 11, further comprising storing, in an attribute storage unit, comparison target character strings, each to be compared with the character string, and comparison target character string attributes, each expressing a meaning attribute of a corresponding one of the comparison target character strings, in association with each other, wherein
the obtaining the character string attribute includes obtaining, as the character string attribute, one of the comparison target character string attributes associated with one of the comparison target character strings that matches the character string in the attribute storage unit.

17. The method according to claim 13, further comprising:
updating the search history storage unit by adding the character string and the at least one of the narrow-down criteria indicated by the selection in the search history storage unit so that the character string and the at least one of the narrow-down criteria are associated with each other; and
updating the search number-of-times storage unit by updating the number of times of at least one of (1) the character string and (2) the at least one of the narrow-down criteria indicated by the selection.

18. The method according to claim 17, wherein
the receiving includes receiving a plurality of character strings as the input,
the updating the search history storage unit includes updating the search history storage unit by adding a set made up of the character strings and the at least one of the narrow-down criteria indicated by the selection to the search history storage unit so that the set and the at least one of the narrow-down criteria are associated with each other, and
the updating the search number-of-times storage unit includes updating the search number-of-times storage unit by updating the number of times corresponding to the set of character strings input by the user.

19. The method according to claim 11, wherein
in a case where a plurality of character strings are received as the input at the receiving, one of the character strings is the character string attribute, and
the obtaining the keyword and the narrow-down criterion includes obtaining, from the search history storage unit, any of the keywords associated with the keyword attributes that respectively match the character string attribute received as the input at the receiving and the character string attribute obtained by the obtaining the character string attribute, as well as the narrow-down criteria for each of the keywords.

20. The method according to claim 11, wherein
the storing the number of times includes storing, in the search number-of-times storage unit, the number of times of the narrow-down criteria, for each category of the narrow-down criteria,
the rearranging includes rearranging the narrow-down criteria, based on the number of times of each category of the narrow-down criteria, and
the generating includes generating a screen for prompting the user to specify a new search criterion, wherein the narrow-down criteria in each category are displayed in a rearranged order on the screen.
